(19) United States
(12) Patent Application Publication
(10) Pub. No.: US 2024/0013040 A1
(43) Pub. Date: Jan. 11, 2024

(54) OUTPUT DRAIN PATH FACILITATING FLEXIBLE SCHEDULE-BASED DEEP NEURAL NETWORK ACCELERATOR

(71) Applicant: Intel Corporation, Santa Clara, CA (US)

(72) Inventors: Arnab Raha, San Jose, CA (US); Deepak Abraham Mathaikutty, Chandler, AZ (US); Umer Iftikhar Cheema, Hillsboro, OR (US); Dinakar Kondru, Frisco, TX (US)

(73) Assignee: Intel Corporation, Santa Clara, CA (US)

(21) Appl. No.: 18/474,464

(22) Filed: Sep. 26, 2023

(51) Int. Cl. G06N 3/063; G06N 3/048; G06N 3/0464

(52) U.S. Cl. CPC G06N 3/063; G06N 3/048; G06N 3/0464

(57) ABSTRACT

A drain module may drain activations in an output tensor of a convolution from a PE array that performs the convolution. The drain module may extract activations generated in a collection of PE columns. The activations generated in the PE columns in the collection may be concatenated, e.g., activations generated in the first PE column of the collection may be followed by activations generated in the second PE column of the collection, and so on. The activations in the output tensor may be rearranged into activation vectors. Each activation vector may include activations in different output channels of the deep learning operation. The activations in each activation vector may have the same (X, Y) coordinate in the output tensor. The drain module may determine a memory address for an activation based on the activation's (X, Y, Z) coordinate in the output tensor and write the activation to the memory address.

### TECHNICAL FIELD

This disclosure relates generally to deep neural networks (DNN), and more specifically, output drain path facilitating flexible schedule-based DNN accelerators.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. DNN inference also requires computation of activation functions. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates an example convolution, in accordance with various embodiments.

FIG. 3 is a block diagram of a DNN system, in accordance with various embodiments.

FIG. 4 illustrates an example processing element (PE) array, in accordance with various embodiments.

FIG. 5 is a block diagram of a PE, in accordance with various embodiments.

FIG. 6 illustrates distribution of a workload for computing an output tensor within a PE array, in accordance with various embodiments.

FIG. 7 illustrates a data loading schedule, in accordance with various embodiments.

FIG. 8 illustrates another data loading schedule, in accordance with various embodiments.

FIG. 9 is a block diagram of a drain module, in accordance with various embodiments.

FIG. 10 is a block diagram of a global drain module, in accordance with various embodiments.

FIGS. 11A and 11B illustrate concatenations of PE outputs, in accordance with various embodiments.

FIGS. 12A and 12B illustrate rearrangement of activations generated by a from a collection of PE columns, in accordance with various embodiments.

FIG. 13 illustrates a data layout in a drain bank of a global drain module, in accordance with various embodiments.

FIG. 14 illustrates an example implementation of a drain module, in accordance with various embodiments.

FIG. 15 illustrates an example multiplexer (MUX) network, in accordance with various embodiments.

FIG. 16 is a block diagram of a DNN module, in accordance with various embodiments.

FIG. 17 is a flowchart showing a method of draining data from a PE array, in accordance with various embodiments.

FIG. 18 is a block diagram of an example computing device, in accordance with various embodiments.

### DETAILED DESCRIPTION

Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations (also referred to as “neural network operations”), such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor (also referred to as “output feature map (OFM)”) that includes one or more output activations (also referred to as “output elements”).

The fundamental operation of a convolution is MAC operations between input activations and kernel weights. Many DNN accelerators implement a fixed schedule representing a fixed data flow for loading activations and weights into PEs. The input tensor dimensions change from one layer to another within a DNN and across different DNNs. For instance, a convolutional layer may have a small number of input channels, while another convolutional layer may have a large number of input channels. With variations in input tensor dimension, a fixed dataflow constrains the types of data movement across the memory hierarchy and limits the degree of reuse within PEs. The data movement of input activations, weights, and partial sums as well as the order of reuse, which determines the distribution of this data, directly correlate to the energy consumed for each layer. Therefore, a DNN accelerator with a fixed schedule may have good performance for certain layers but can have poor performance for other layers that have different input tensor dimensions.

Some DNN accelerators can facilitate flexible schedules of loading activations and weights into PE arrays to maximize PE utilization. These DNN accelerators may modify tensor shape (e.g., shape of the input tensor) or internal compute configuration on a layer level. Different layers (e.g., different convolutional layers) may be performed using different loading schedules. One of the unique advantages of a flexible DNN accelerator design is its ability to switch among multiple schedules based on the layer characteristics that minimizes the number of memory accesses for a given tensor operation leading to significant accelerator-level energy savings. A way to introduce the ability to adapt to different layer schedules is to implement the schedule-based data movement and processing logic within the load, compute, and drain units—the three main components of a DNN accelerator. However, this complicates the overall implementation of the flexible DNN accelerator while adding significant area and power overhead to the DNN accelerator.

Embodiments of the present disclosure may improve on at least some of the challenges and issues described above by providing drain modules that can facilitate flexible schedule-based DNN accelerators. An example drain module can drain activations computed by PEs in a fixed output-channel-major order, despite the flexible schedules programmed in the DNN accelerator. Activations computed by PEs may be activations in an output tensor of a DNN layer. The output tensor may be a three-dimensional tensor that includes a plurality of output channels. Output channels of a DNN layer may become input channels of the next layer. An activation in the output tensor may have an (X, Y, Z) coordinate, where the Z coordinate may indicate which output channel the activation is in. With the fixed output-channel-major order, the output tensor may be drained as a plurality of activation vectors. The activations in an activation vector may have the same (X, Y) coordinate but have different Z coordinates from each other. Due to the MAC operations on activations and weights along the input channel dimension, the fixed drain pattern can result in the extraction of output activations in a fixed input-channel-major fashion for any DNN layer schedule programmed in the flexible DNN accelerator. This fixed way of draining can simplify the drain design by introducing (and reusing) the schedule-awareness complexity within the already overloaded load logic. The drain module can be schedule-aware for exploiting data reuse based on an optimal schedule for a specific layer and can absorb the additional functionality with low overhead.

In various embodiments of the present disclosure, a drain module in a DNN accelerator may drain activations in an output tensor of a deep learning operation from a PE array that performs the deep learning operation. The drain module may further reconstruct the output activations into a 1×1×Z data layout, Z may correspond to the output channels of the deep learning operation, which may be input channels of the next deep learning operation. For instance, the drain module may extract activations generated in a collection of PE columns, each PE column includes one or more PEs that compute one or more activations. The activations generated in a PE column may be stored in a column buffer. The activations stored in column buffers corresponding to the PE column in the collection may be concatenated. Activations generated in the first PE column of the collection may be followed by activations generated in the second PE column of the collection, and so on. After the concatenation, the activations may be rearranged into activation vectors. Each activation vector may include a sequence of activations that are in different output channels of the deep learning operation. The activations in each activation vector may have the same (X, Y) coordinate in the output tensor. The drain module may determine a memory address for an activation based on the activation's (X, Y, Z) coordinate in the output tensor and write the activation into a memory at the memory address.

Compared to DNN accelerators that implements a fixed schedule, DNN accelerators in the present disclosure can facilitate flexible schedules, which can lead to significant performance and energy improvements. With the drain modules in the present disclosure, output feature maps can be stored in the memory in a fixed pattern irrespective of the different DNN layer schedules so that it can be efficiently loaded using the schedule-aware data load unit of a flexible DNN accelerator. With such drain modules, schedule-aware DNN accelerators can have significant performance and energy improvements for each layer of DNN resulting in sweeping overall benefits at the network-level for small area and power overheads.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN

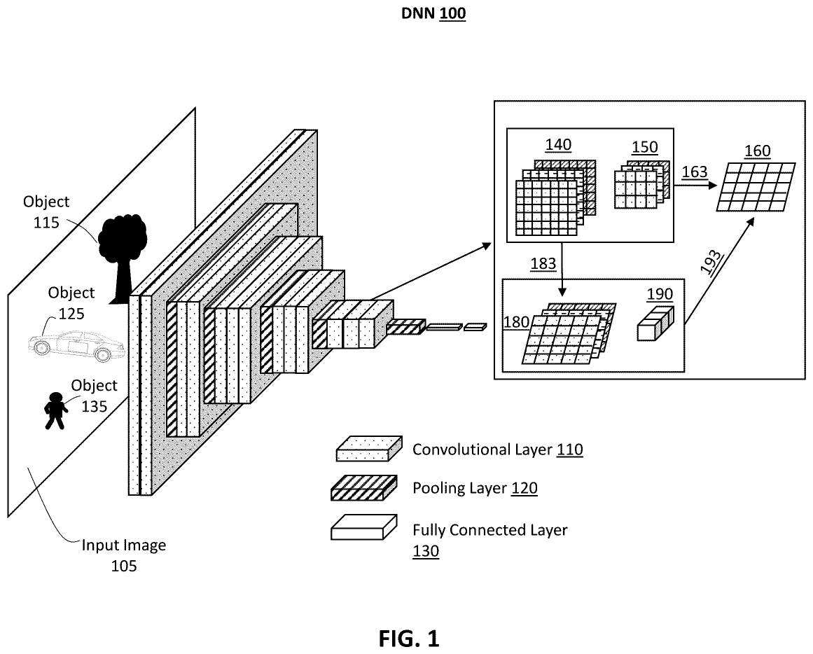

FIG. 1 illustrates an example DNN 100, in accordance with various embodiments. For the purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is rectified linear unit (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generate a new feature map. The new feature map may also be normalized and resized. The new feature map can be kernelled again by a further subsequent convolutional layer 110, and so on.

In some embodiments, a convolutional layer 110 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between two convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU, etc.) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a SoftMax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, SoftMax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

Example Convolution

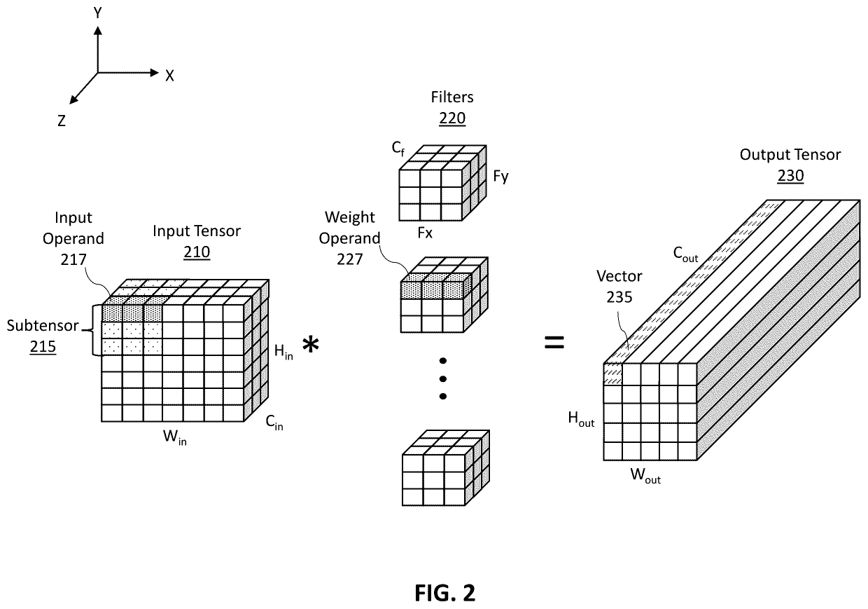

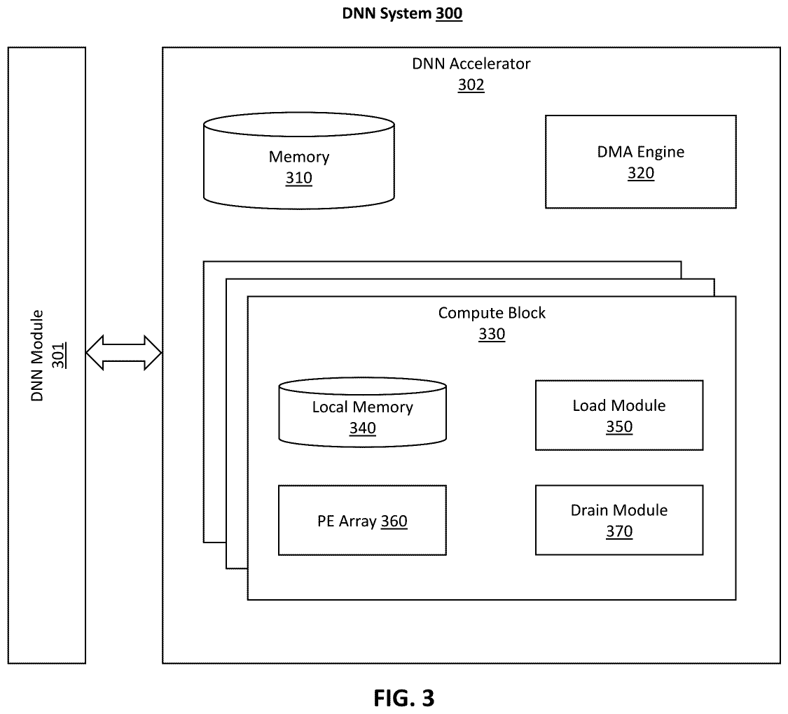

FIG. 2 illustrates an example convolution, in accordance with various embodiments. The convolution may be a deep learning operation in a convolutional layer of a DNN, e.g., a convolutional layer 110 in FIG. 1. The convolution can be executed on an input tensor 210 and filters 220 (individually referred to as “filter 220”). The result of the convolution is an output tensor 230. In some embodiments, the convolution is performed by a DNN accelerator. An example of the DNN accelerator may be the DNN accelerator 302 in FIG. 3.

In the embodiments of FIG. 2, the input tensor 210 includes activations (also referred to as “input activations,” “elements,” or “input elements”) arranged in a 3D matrix. An input element is a data point in the input tensor 210. The input tensor 210 has a spatial size Hᵢₙ×Wᵢₙ×Cᵢₙ, where Hᵢₙ is the height of the 3D matrix (i.e., the length along the Y axis, which indicates the number of activations in a column in the 3D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For the purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C f is the depth of the filter (i.e., the length along the Z axis, which indicates the number of channels). In some embodiments, C_{f} equals Cᵢₙ. For purpose of simplicity and illustration, each filter 220 in FIG. 2 has a spatial size of 2×3×3, i.e., the filter 220 includes 2 convolutional kernels with a spatial size of 2×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has an INT8 format, the activation takes one byte. When the activation or weight has a FP16 format, the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An output activation is a data point in the output tensor 230. The output tensor 230 has a spatial size Hₒᵤₜ×Wₒᵤₜ×Lₒᵤₜ, where Hour is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 220 in the convolution. Hour and Wₒᵤₜ may depend on the heights and weights of the input tensor 210 and each filter 220.

As a part of the convolution, MAC operations can be performed on a 2×3×3 subtensor 215 (which is highlighted with a dotted pattern in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (X, Y) coordinate, but the output activations correspond to different output channels and have different Z coordinates. The dimension of the vector 235 along the Z axis may equal the total number of output channels in the output tensor 230. After the vector 235 is produced, further MAC operations are performed to produce additional vectors till the output tensor 230 is produced.

In some embodiments, the MAC operations on a 2×3×3 subtensor (e.g., the subtensor 215) and a filter 220 may be performed by a plurality of PEs. One or more PEs may receive an input operand (e.g., an input operand 217 shown in FIG. 2) and a weight operand (e.g., the weight operand 227 shown in FIG. 2). The input operand 217 includes a sequence of activations having the same (X, Y) coordinate but different z coordinates. The input operand 217 includes an activation from each of the input channels in the input tensor 210. The weight operand 227 includes a sequence of weights having the same (X, Y) coordinate but different z coordinates. The weight operand 227 includes a weight from each of the channels in the filter 220. Activations in the input operand 217 and weights in the weight operand 227 may be sequentially fed into a PE. The PE may receive an activation and a weight (“an activation-weight pair”) at a time and multiple the activation and the weight. The position of the activation in the input operand 217 may match the position of the weight in the weight operand 227. The activation and weight may correspond to the same channel.

Activations or weights may be floating-point numbers. Floating-point numbers may have various data formats, such as FP32, FP16, BF16, and so on. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

In some embodiments, the output activations in the output tensor 230 may be further processed based on one or more activation functions before they are stored or inputted into the next layer of the DNN. The processing based on the one or more activation functions may be at least part of the post processing of the convolution. In some embodiments, the post processing may include one or more other computations, such as offset computation, bias computation, and so on. The results of the post processing may be stored in a local memory of the compute block and be used as input to the next DNN layer. In some embodiments, the input activations in the input tensor 210 may be results of post processing of the previous DNN layer.

Example DNN System

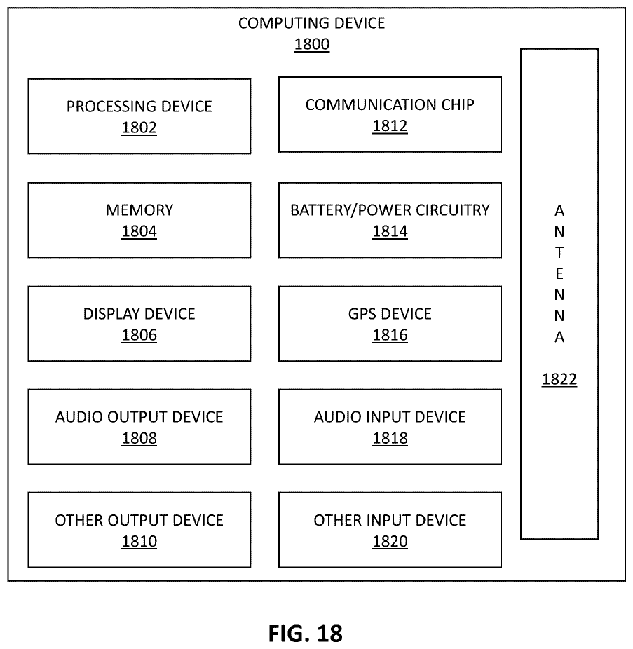

FIG. 3 is a block diagram of a DNN system 300, in accordance with various embodiments. The whole DNN system 300 or a part of the DNN system 300 may be implemented in one or more computing devices, such as the computing device 1800 in FIG. 18. The DNN system 300 can generate and execute DNNs, such as the DNN 100 in FIG. 1. As shown in FIG. 3, the DNN system 300 includes a DNN module 301 and a DNN accelerator 302. In other embodiments, alternative configurations, different or additional components may be included in the DNN system 300. For instance, the DNN system 300 may include multiple DNN modules or multiple DNN accelerators. Further, functionality attributed to a component of the DNN system 300 may be accomplished by a different component included in the DNN system 300 or a different system. In some embodiments, the DNN module 301 and DNN accelerator 302 may include different types of processing units. The DNN module 301 and DNN accelerator 302 may be implemented in the same chip or separate chips.

The DNN module 301 facilitates generation and deployment of DNNs. In some embodiments, the DNN module 301 may generate and train DNNs. For instance, the DNN module 301 can define the layered architecture of a DNN. The DNN module 301 can also determine the internal parameters of the DNN through a DNN training process. The DNN module 301 may also determine one or more hyperparameters that define how the DNN is trained. An example hyperparameter is a sparsity ratio that defines the sparsity level of one or more deep learning tensors for the DNN.

The DNN module 301 may also compress DNNs, e.g., during or after training. In some embodiments, the DNN module 301 may prune weights in one or more layers of a DNN by changing nonzero valued weight to zeros. The DNN module 301 may prune weights based on a target weight sparsity ratio. A weight sparsity ratio may be the ratio of the number of zero-valued weights to the total number of weights. In an example where the DNN module 301 prunes weight during DNN training, the DNN module 301 may prune weight of a layer to achieve a target sparsity ratio after one or more epochs. The DNN module 301 may prevent the pruned weights from changing values during the rest of the training process. Alternatively, the DNN module 301 may allow the pruned weights to change values so that a pruned, zero-valued weight may have a nonzero value after further training. The DNN module 301 may prune weights of the layer again after one or more additional epochs.

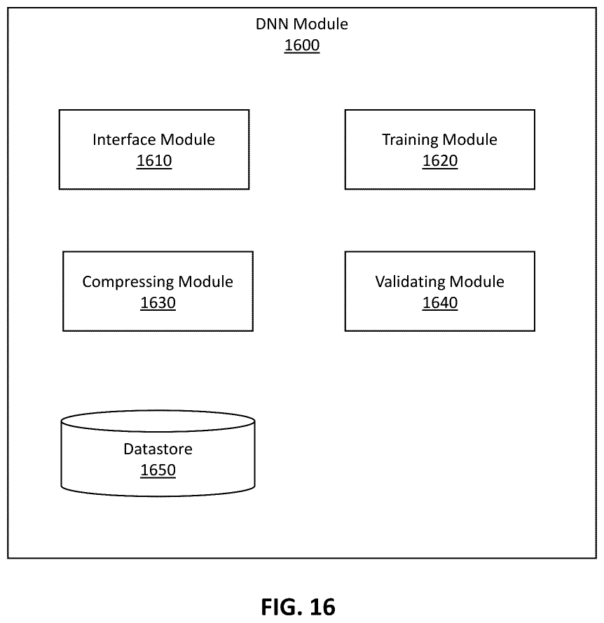

The DNN module 301 may deploy trained, compressed, or validated DNNs for use in deep learning applications. The DNN module 301 may control inference processes of trained, compressed, or validated DNNs. In some embodiments, the DNN module 301 may distribute trained, compressed, or validated DNNs to devices or systems which may use the DNNs to perform tasks (e.g., image classification, motion planning, etc.) for which the DNNs were trained. In other embodiments, the DNN module 301 may facilitate deployment of the DNNs using the DNN accelerator 302. For instance, the DNN module 301 may receive data from a device or system coupled with the DNN system 300 and input the received data (or data generated by the DNN module 301, e.g., based on the received data) into a DNN. The DNN module 301 may generate instructions (e.g., configuration files) that control the operation of the DNN accelerator 302 during the DNN inference. The DNN module 301 may receive an output of the DNN from the DNN accelerator 302. The DNN module 301 may transmit the output of the DNN (or a result of processing the output of the DNN by the DNN module 301) to the device or system. Certain aspects of the DNN module 301 are provided below in conjunction with FIG. 16.

The DNN accelerator 302 executes DNNs provided by the DNN module 301. For instance, the DNN accelerator 302 can perform DNN inference, e.g., by running deep learning operations in the DNNs, for training DNNs or for using the trained/compressed/validated DNNs to perform tasks. As shown in FIG. 3, the DNN accelerator 302 includes a memory 310, a DMA (direct memory access) engine 320, and compute blocks 330 (individually referred to as “compute block 330”). In other embodiments, alternative configurations, different or additional components may be included in the DNN accelerator 302. For example, the DNN accelerator 302 may include more than one memory 310 or DMA engine 320. As another example, the DNN accelerator 302 may include a single compute block 330. Further, functionality attributed to a component of the DNN accelerator 302 may be accomplished by a different component included in the DNN accelerator 302 or by a different system. A component of the DNN accelerator 302 may be implemented in hardware, software, firmware, or some combination thereof.

The memory 310 stores data associated with deep learning operations performed by the DNN accelerator. In some embodiments, the memory 310 may store data to be used by the compute blocks 330 for DNN inference. For example, the memory 310 may store weights, such as weights of convolutional layers, which are determined by training DNNs. As another example, the memory 310 may store inputs to DNNs or outputs of DNNs. The memory 310 may also store data generated by the compute blocks 330 from performing deep learning operations in DNNs. Example deep learning operations include convolutions (also referred to as “convolutional operations”), pooling operations, elementwise operations, activation functions, other types of deep learning operations, or some combination thereof. The memory 310 may be a main memory of the DNN accelerator 302. In some embodiments, the memory 310 includes one or more dynamic random-access memories (DRAMs).

The DMA engine 320 facilitates data transfer between the memory 310 and local memories of the compute blocks 330. For example, the DMA engine 320 can read data from the memory 310 and write data into a local memory of a compute block 330. As another example, the DMA engine 320 can read data from a local memory of a compute block 330 and write data into the memory 310. The DMA engine 320 provides a DMA feature that allows the compute block 330 to initiate data transfer between the memory 310 and the local memories of the compute blocks 330 and to perform other operations while the data transfer is in being conducted. In some embodiments, the DMA engine 320 may read tensors from the memory 310, modify the tensors in a way that is optimized for the compute block 330 before it writes the tensors into the local memories of the compute blocks 330.

The compute blocks 330 can perform deep learning operations in DNNs. For instance, a compute block 330 may run a deep learning operation in a DNN layer, or a portion of the deep learning operation, at a time. The compute blocks 330 may be capable of running various types of deep learning operations, such as convolution, pooling, elementwise operation, linear operation, nonlinear operation, and so on. In an example, a compute block 330 may perform convolutions, e.g., standard convolution or depthwise convolution. In some embodiments, the compute block 330 receives an input tensor and one or more convolutional kernels and performs a convolution with the input tensor and convolutional kernels. The result of the convolution may be an output tensor, which can be further computed, e.g., by the compute block 330 or another compute block 330. In some embodiments, the operations of the DNN layers may be run by multiple compute blocks 330 in parallel. For instance, multiple compute blocks 330 may each perform a portion of a workload for a convolution. Data may be shared between the compute blocks 330. A compute block 330 may also be referred to as a compute tile. In some embodiments, each compute block 330 may be a processing unit.

In the embodiments of FIG. 3, each compute block 330 includes a local memory 340, a load module 350, a PE array 360, and a drain module 370. Some or all the components of the compute block 330 can be implemented on the same chip. In other embodiments, alternative configurations, different or additional components may be included in the compute block 330. Further, functionality attributed to a component of the compute block 330 may be accomplished by a different component included in the compute block 330, a different compute block 330, another component of the DNN accelerator 302, or a different system. A component of the compute block 330 may be implemented in hardware, software, firmware, or some combination thereof.

The local memory 340 is local to the corresponding compute block 330. In the embodiments of FIG. 3, the local memory 340 is inside the compute block 330. In other embodiments, the local memory 340 may be outside the compute block 330. Data in the local memory 340 may be transferred to or from the memory 310, e.g., through the DMA engine 320. In some embodiments, data in the local memory 340 may be transferred to or from the local memory of another compute block 330. The local memory 340 may store data received, used, or generated by the PE array 360 and the post processing unit 950. Examples of the data may include input activations, weights, output activations, sparsity bitmaps, and so on.

In some embodiments, the local memory 340 may store dense tensors (e.g., dense activation tensors, dense weight tensors, etc.), sparse tensors (e.g., sparse activation tensors, sparse weight tensors, etc.), and so on. A dense tensor may be a tensor from which zero-valued elements (if any) are not removed. A dense tensor may be converted to a sparse tensor by removing one or more zero-valued elements in the dense tensor. A sparse tensor may also be referred to as a compressed tensor or packed tensor. The process of converting a dense tensor to a sparse tensor may be referred to as sparsity encoding. Sparsity encoding may also generate a sparsity tensor. Each element in the sparsity tensor may correspond to a different element in the dense tensor and indicate whether the element in the dense tensor is zero or not. The sparsity tensor may indicate positions of elements of the sparse tensor in the dense tensor. The sparsity tensor may be a sparsity bitmap, each element of which is a bit. A sparse tensor may be converted to a dense tensor through a densifying process, in which one or more zeros may be added to the sparse tensor based on the sparsity tensor.

In some embodiments, the local memory 340 includes one or more static random-access memories (SRAMs). The local memory 340 may be byte-addressable, and each memory address identifies a single byte (eight bits) of storage. In some embodiments, the local memory 340 may include memory banks. The number of data banks in the local memory 340 may be 16, 64, 128, 356, 512, 1024, 3048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 340 in a single read cycle. In other embodiments, 16 bits can be transferred from the local memory 340 in multiple read cycles, such as two cycles.

The load module 350 loads data from the local memory 340 to the PE array 360. The load module 350 may read data from the local memory 340. The data may include activations, weights, sparsity tensors, and so on. In some embodiments, the load module 350 may load data of a DNN layer to the PE array 360 based on a schedule configured specifically for the DNN layer. A schedule may indicate how the workload of computing the output tensor of the layer is divided and distributed to the PEs in the PE array 360 so that the input activations and weights can be loaded to the PEs accordingly.

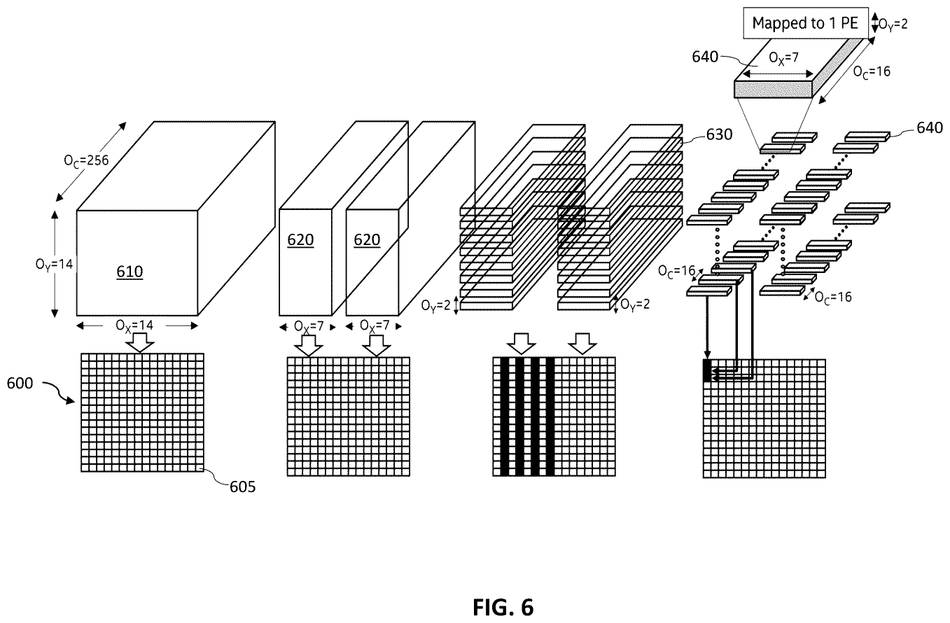

In some embodiments, the schedule may specify a loop order. The loop order may be an order of X, Y, input channel (IC), and output channel (OC). The loop order may be determined based on the shape of the input tensor or a shape of the output tensor of the DNN layer. For instance, a DNN layer with a small number of input channels may have IC before OC in the loop order, while a DNN layer with a large number of input channels may have OC before IC in the loop order. The schedule may also specify one or more loop blocking parameters and one or more loop partitioning parameters. Loop blocking parameters and loop partitioning parameters may indicate the amount of data (or amount of workload) allocated within a single PE in the PE array 360. For instance, the loop partitioning parameter may indicate how the total workload is partitioned among the PEs. The lock blocking parameter may indicate how many activations in each dimension are mapped to a single PE. The load module 350 may load activations and weights into the PEs in accordance with the loop order, loop blocking parameters, and loop partitioning parameters. In some embodiments, loop orders, loop blocking parameters, or loop partitioning parameters may be determined by the DNN module 301. More details regarding loading data to PE arrays are described below in conjunction with FIGS. 6-8.

The PE array 360 may include PEs arranged in columns, or columns and rows. Each PE can perform MAC operations. In some embodiments, a PE includes one or more multipliers for performing multiplications. An PE may also include one or more accumulators (“adders”) for performing accumulations. A column of PEs is referred to as a PE column. A PE column may be associated with one or more MAC lanes. A MAC lane is a path for loading data into a MAC column. A MAC lane may be also referred to as a data transmission lane or data loading lane. A PE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

In some embodiments, the PE array 360 may be capable of depthwise convolution, standard convolution, or both. In a depthwise convolution, a PE may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 360 may output multiple output operands at a time, each of which is generated by a different PE. In a standard convolution, MAC operations may include accumulations across the channels. For instance, as opposed to generating an output operand, a PE may accumulate products across different channels to generate a single output point.

In some embodiments, the PE array 360 may perform MAC operations in quantized inference, such as MAC operations in a quantized convolution. In some embodiments, a PE in the PE array 360 may receive quantized activation and quantized weights and compute a quantized MAC result. The quantized MAC result may be a quantized value in an integer format and may be the output of the PE. In some embodiments, the PE may also include a quantization multiplier that can multiply a quantization scale with the quantized MAC result, and the output of the PE may be a real value in a floating-point format. The PE may include no quantization subtractors as zero-point offsetting is not needed for the MAC operations in quantized inference.

The drain module 370 drains data from the PE array 360 and writes the data to the local memory 340. The data may be outputs of MAC operations performed by PEs in the PE array 360. In some embodiments, the drain module 370 may support flexible schedules with which the load module 350 load data into the PEs. Flexible schedules have flexible loop orders, so the layout of activations output from the PEs can also be flexible. The drain module 370 may convert flexible layouts of output activations into a fixed layout, where output activations having the same (X, Y) coordinates are grouped together so that the fixed layout has a 1×1×Z or 1×1×OC pattern. In an example, the fixed layout may have a plurality of activation vectors, each activation vector may have a size of 1×1×Z, where Z is the number of output channels of the convolution. The output channels of the convolution may be the input channels of the next convolution.

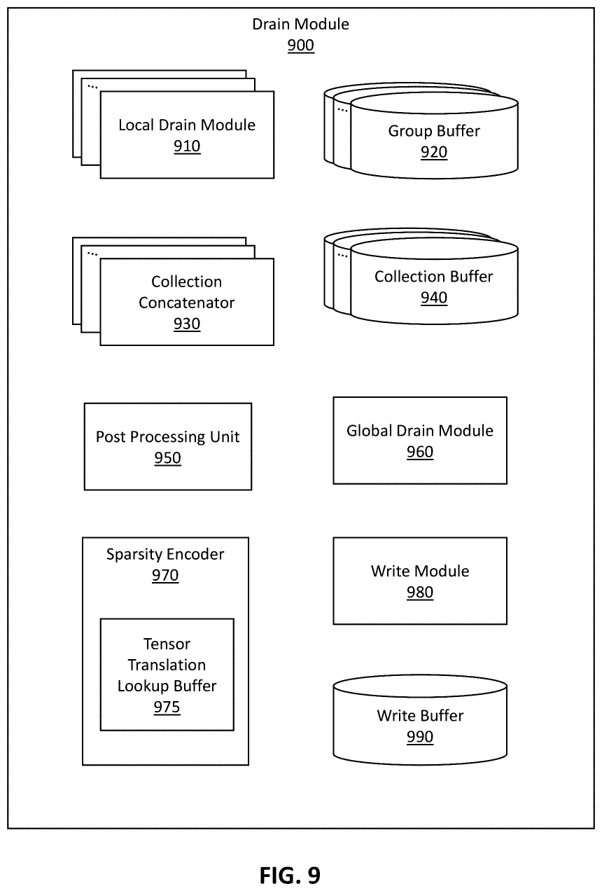

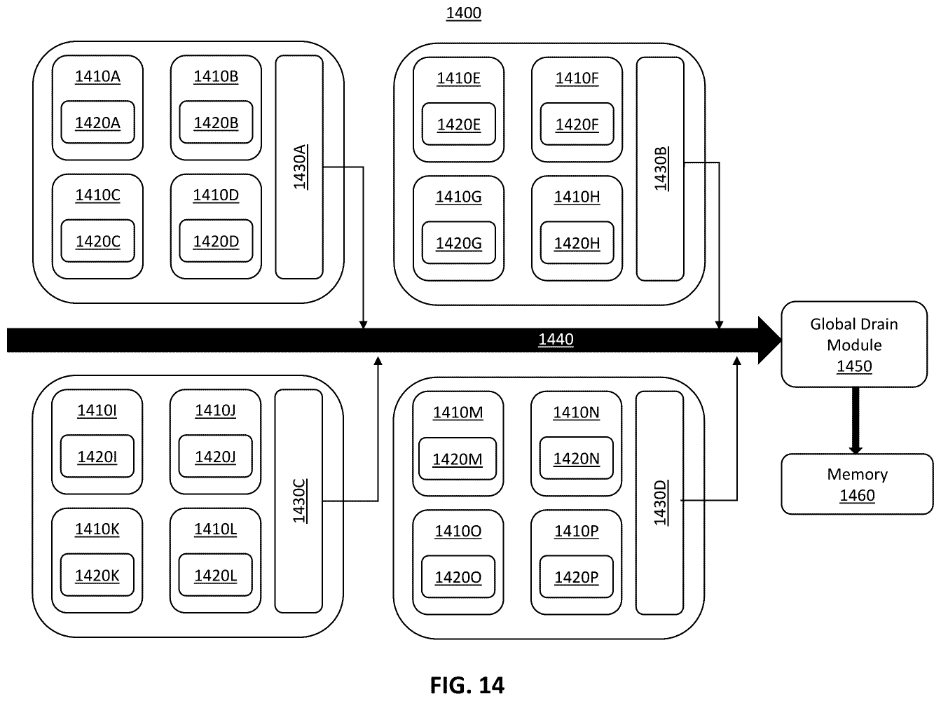

The drain module 370 may also include sparsity encoding logic (e.g., a sparsity encoder) that can convert outputs of the PE array 360 from a dense format to a sparse format. In some embodiments, the data drained from the PE array 360 may be at least part of an output tensor (e.g., the output tensor 230 in FIG. 2) of a deep learning operation. The sparsity encoder may generate a compressed version of the output tensor. The sparsity encoder may identify every zero-valued activation in the output tensor and remove these activations from the output tensor to generate a sparse activation tensor. The sparsity encoder may also generate one or more sparsity tensors for the output tensor. A sparsity bitmap may correspond to a vector (e.g., the vector 235 in FIG. 2) in the output tensor. The sparsity map may include sparsity elements (e.g., bits), each of which corresponds to a different activation in the vector and indicates whether the corresponding activation is zeroed or not. The drain module 370 may write the sparse activation tensor and the one or more sparsity tensors into the local memory 340. The sparse activation tensor and the one or more sparsity tensors may be further loaded to the memory 310, e.g., through the DMA engine 320. Additionally or alternatively, the sparse activation tensor and the one or more sparsity tensors may be loaded by the load module 350 to the sparse cell array for further computation, e.g., for performing a deep learning operation in the next layer. Certain aspects of the drain module 370 are described below in conjunction with FIGS. 9 and 14.

Example PE Array

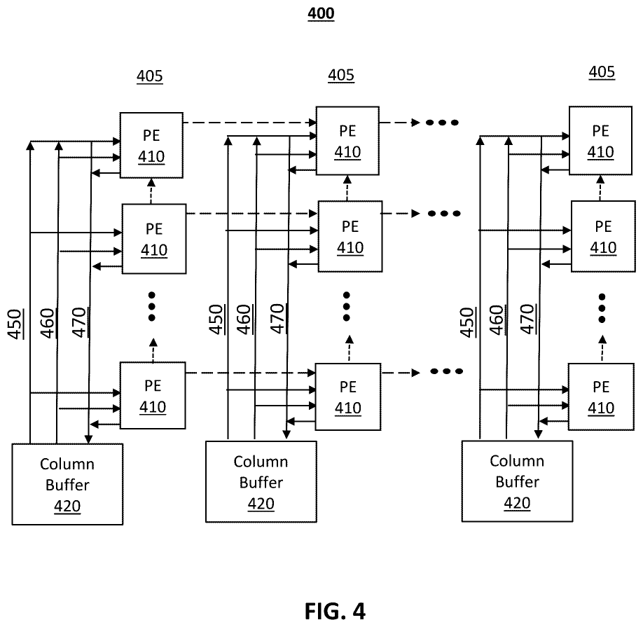

FIG. 4 illustrates an example PE array, in accordance with various embodiments. The PE array 400 may be an embodiment of the PE array 360 in FIG. 3. The PE array 400 includes a plurality of PEs 410 (individually referred to as “PE 410”). The PEs 410 can perform MAC operations, including MAC operations in quantized inference. The PEs 410 may also be referred to as neurons in the DNN. Each PE 410 has two input signals 450 and 460 and an output signal 470. The input signal 450 is at least a portion of an IFM to the layer. The input signal 460 is at least a portion of a filter of the layer. In some embodiments, the input signal 450 of a PE 410 includes one or more input operands, and the input signal 460 includes one or more weight operands.

Each PE 410 performs an MAC operation on the input signals 450 and 460 and outputs the output signal 470, which is a result of the MAC operation. Some or all of the input signals 450 and 460 and the output signal 470 may be in an integer format, such as INT8, or floating-point format, such as FP16 or BF16. For the purpose of simplicity and illustration, the input signals and output signal of all the PEs 410 have the same reference numbers, but the PEs 410 may receive different input signals and output different output signals from each other. Also, a PE 410 may be different from another PE 410, e.g., including more, fewer, or different components.

As shown in FIG. 4, the PEs 410 are connected to each other, as indicated by the dash arrows in FIG. 4. The output signal 470 of an PE 410 may be sent to many other PEs 410 (and possibly back to itself) as input signals via the interconnections between PEs 410. In some embodiments, the output signal 470 of an PE 410 may incorporate the output signals of one or more other PEs 410 through an accumulate operation of the PE 410 and generates an internal partial sum of the PE array.

In the embodiments of FIG. 4, the PEs 410 are arranged into columns 405 (individually referred to as “column 405”). The input and weights of the layer may be distributed to the PEs 410 based on the columns 405. Each column 405 has a column buffer 420. The column buffer 420 stores data provided to the PEs 410 in the column 405 for a short amount of time. The column buffer 420 may also store data output by the last PE 410 in the column 405. The output of the last PE 410 may be a sum of the MAC operations of all the PEs 410 in the column 405, which is a column-level internal partial sum of the PE array 400. In other embodiments, input and weights may be distributed to the PEs 410 based on rows in the PE array 400. The PE array 400 may include row buffers in lieu of column buffers 420. A row buffer may store input signals of the PEs in the corresponding row and may also store a row-level internal partial sum of the PE array 400.

In some embodiments, a column buffer 420 may be a portion of the local memory 340 in FIG. 3. The column buffer 420 may be associated with upper memory hierarchies, e.g., the memory 310 in FIG. 3. Data in the column buffer 420 may be sent to the upper memory hierarchies. The column buffer 420 may receive data from the upper memory hierarchies.

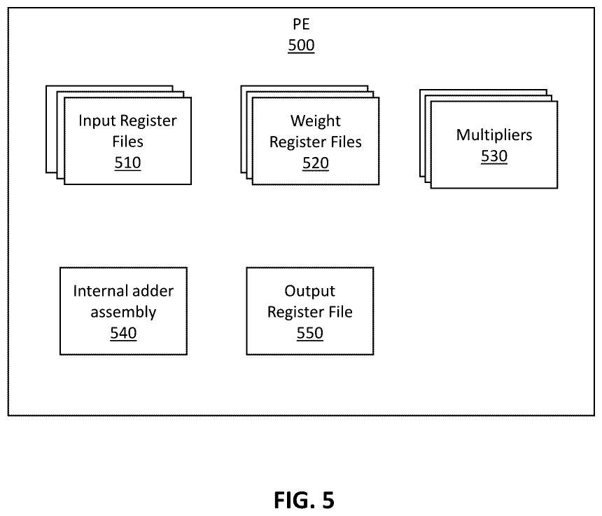

FIG. 5 is a block diagram of a PE 500, in accordance with various embodiments. The PE 500 may be an embodiment of the PE 410 in FIG. 4 or an embodiment of a PE in the PE array 360 in FIG. 3. The PE 500 may perform MAC operations, e.g., MAC operations using data in integer formats. As shown in FIG. 5, the PE 500 includes input register files 510 (individually referred to as “input register file 510”), weight registers file 520 (individually referred to as “weight register file 520”), multipliers 530 (individually referred to as “multiplier 530”), an internal adder assembly 540, and an output register file 550. In other embodiments, the PE 500 may include fewer, more, or different components. For example, the PE 500 may include multiple output register files 550. As another example, the PE 500 may include a single input register file 510, weight register file 520, or multiplier 530. As yet another example, the PE 500 may include an adder in lieu of the internal adder assembly 540.

The input register files 510 temporarily store input operands for MAC operations by the PE 500. In some embodiments, an input register file 510 may store a single input operand at a time. In other embodiments, an input register file 510 may store multiple input operand or a portion of an input operand at a time. An input operand includes a plurality of input elements (i.e., input elements) in an input tensor. The input elements of an input operand may be stored sequentially in the input register file 510 so the input elements can be processed sequentially. In some embodiments, each input element in the input operand may be from a different input channel of the input tensor. The input operand may include an input element from each of the input channels of the input tensor, and the number of input elements in an input operand may equal the number of the input channels. The input elements in an input operand may have the same (X, Y) coordinates, which may be used as the (X, Y) coordinates of the input operand. For instance, all the input elements of an input operand may be X0Y0, X0Y1, X1Y1, etc.

The weight register file 520 temporarily stores weight operands for MAC operations by the PE 500. The weight operands include weights in the filters of the DNN layer. In some embodiments, the weight register file 520 may store a single weight operand at a time. other embodiments, an input register file 510 may store multiple weight operands or a portion of a weight operand at a time. A weight operand may include a plurality of weights. The weights of a weight operand may be stored sequentially in the weight register file 520 so the weight can be processed sequentially. In some embodiments, for a multiplication operation that involves a weight operand and an input operand, each weight in the weight operand may correspond to an input element of the input operand. The number of weights in the weight operand may equal the number of the input elements in the input operand.

In some embodiments, a weight register file 520 may be the same or similar as an input register file 510, e.g., having the same size, etc. The PE 500 may include a plurality of register files, some of which are designated as the input register files 510 for storing input operands, some of which are designated as the weight register files 520 for storing weight operands, and some of which are designated as the output register file 550 for storing output operands. In other embodiments, register files in the PE 500 may be designated for other purposes, e.g., for storing scale operands used in elementwise add operations, etc.

The multipliers 530 perform multiplication operations on input operands and weight operands. A multiplier 530 may perform a sequence of multiplication operations on a single input operand and a single weight operand and generate a product operand including a sequence of products. Each multiplication operation in the sequence includes multiplying an input element in the input operand and a weight in the weight operand. In some embodiments, a position (or index) of the input element in the input operand matches the position (or index) of the weight in the weight operand. For instance, the first multiplication operation is a multiplication of the first input element in the input operand and the first weight in the weight operand, the second multiplication operation is a multiplication of the second input element in the input operand and the second weight in the weight operand, the third multiplication operation is a multiplication of the third input element in the input operand and the third weight in the weight operand, and so on. The input element and weight in the same multiplication operation may correspond to the same depthwise channel, and their product may also correspond to the same depthwise channel.

Multiple multipliers 530 may perform multiplication operations simultaneously. These multiplication operations may be referred to as a round of multiplication operations. In a round of multiplication operations by the multipliers 530, each of the multipliers 530 may use a different input operand and a different weight operand. The different input operands or weight operands may be stored in different register files of the PE 500. For instance, a first multiplier 530 uses a first input operand (e.g., stored in a first input register file 510) and a first weight operand (e.g., stored in a first weight register file 520), versus a second multiplier 530 uses a second input operand (e.g., stored in a second input register file 510) and a second weight operand (e.g., stored in a second weight register file 520), a third multiplier 530 uses a third input operand (e.g., stored in a third input register file 510) and a third weight operand (e.g., stored in a third weight register file 520), and so on. For an individual multiplier 530, the round of multiplication operations may include a plurality of cycles. A cycle includes a multiplication operation on an input element and a weight.

The multipliers 530 may perform multiple rounds of multiplication operations. A multiplier 530 may use the same weight operand but different input operands in different rounds. For instance, the multiplier 530 performs a sequence of multiplication operations on a first input operand stored in a first input register file in a first round, versus a second input operand stored in a second input register file in a second round. In the second round, a different multiplier 530 may use the first input operand and a different weight operand to perform another sequence of multiplication operations. That way, the first input operand is reused in the second round. The first input operand may be further reused in additional rounds, e.g., by additional multipliers 530.

The internal adder assembly 540 includes one or more adders inside the PE 500, i.e., internal adders. The internal adder assembly 540 may perform accumulation operations on two or more products operands from multipliers 530 and produce an output operand of the PE 500. In some embodiments, the internal adders are arranged in a sequence of tiers. A tier includes one or more internal adders. For the first tier of the internal adder assembly 540, an internal adder may receive product operands from two or more multipliers 530 and generate a sum operand through a sequence of accumulation operations. Each accumulation operation produces a sum of two or more products, each of which is from a different multiplier 530. The sum operand includes a sequence of sums, each of which is a result of an accumulation operation and corresponds to a depthwise channel. For the other tier(s) of the internal adder assembly 540, an internal adder in a tier receives sum operands from the precedent tier in the sequence. Each of these numbers may be generated by a different internal adder in the precedent tier. A ratio of the number of internal adders in a tier to the number of internal adders in a subsequent tier may be 2:1. In some embodiments, the last tier of the internal adder assembly 540 may include a single internal adder, which produces the output operand of the PE 500.

The output register file 550 stores output operands of the PE 500. In some embodiments, the output register file 550 may store an output operand at a time. In other embodiments, the output register file 550 may store multiple output operands or a portion of an output operand at a time. An output operand includes a plurality of output elements in an IFM. The output elements of an output operand may be stored sequentially in the output register file 550 so the output elements can be processed sequentially. In some embodiments, each output element in the output operand corresponds to a different depthwise channel and is an element of a different output channel of the output channel of the depthwise convolution. The number of output elements in an output operand may equal the number of the depthwise channels of the depthwise convolution.

Example Data Loading Schedule

FIG. 6 illustrates distribution of a workload for computing an output tensor 610 within a PE array 600, in accordance with various embodiments. For instance, the PE array 600 may perform MAC operations in a deep learning operation (e.g., a convolution) to compute the output tensor 610. The PE array 600 may be an example of the PE array 360 in FIG. 3. The output tensor 610 may be an example of the output tensor 230 in FIG. 2. The distribution of the workload may be performed by a load module (not shown in FIG. 6) associated with the PE array 600, such as the load module 350.

For the purpose of simplicity and illustration, the PE array 600 includes 256 PEs arranged in 16 columns and 16 rows, and the output tensor 610 has a spatial size of 14×14×256, meaning there are 256 output channels (denoted as “Oc” in FIG. 6), and each output channel has a 2D matrix with a width of 14 (denoted as “Ox” in FIG. 6) and a height of 14 (denoted as “Oy” in FIG. 6). Each activation in the output tensor 610 may have a (OX, OY, OC) coordinate that indicates the position of the activation in the output tensor, where OX indicates X coordinate in the output tensor, OY indicates Y coordinate in the output tensor, and OC indicates output channel. Even though not shown in FIG. 6, the PE array 600 may also receive weights. A weight may have a (FX, FY) coordinate that indicates the position of the weight in a kernel or a (FX, FY, IC, OC) coordinate, where IC denotes input channel of the deep learning operation.

The PE array 600 may perform the MAC operations may be performed across multiple input channels between the input activations (i.e., activations in the input tensor, e.g., the input tensor 210 in FIG. 2) and weights and generate output activations, i.e., activations in the output tensor 610. The PE array 600 may be in a DNN accelerator that can facilitate flexible schedules of loading data into the PE array 600 and therefore, achieve high utilizations of the PEs 605 despite variations in the input tensor dimensions across different DNN layers or different DNNs.

The load module may define a data loading schedule based on a loop order, loop partitioning parameter, and loop blocking parameter. The loop order may determine the relative order of IX, IY (spatial), and IC dimensions for activations and FX, FY, IC, OC dimensions for filters in which these data are loaded within the DNN accelerator. The loop order may also determine the order in which the output points are created in terms of OX, OY, and OC. The loop blocking parameter and loop partitioning parameter may determine the amount of data (or amount of workload) allocated within a PE 605 and across different PEs 605. The loop partitioning parameter may indicate how the total workload of the deep learning operation is partitioned among the PEs. The lock blocking parameter may indicate how many activations in each dimension are mapped to the same PE 605.

In the example illustrated by FIG. 6, the output tensor 610 is divided to two tensors 620 (individually referred to as “tensor 620”) in the OX dimension. Each tensor 620 has a spatial size of 7×14×256. Further, each tensor 620 is divided into seven tensors 630 (individually referred to as “tensor 630”) in the OY dimension. Each tensor 630 has a spatial size of 7×2×256. Then each tensor 630 is divided into 16 tensor 640 (individually referred to as “tensor 640”) in the OC dimension. Each tensor 640 has a spatial size of 7×2×16 and would be computed by a single PE 605. In other words, the single PE 605 would receive the workload of computing the tensor 640 and would receive input activation and weights needed for computing the tensor 640. The output activations, after generated, would be drained from the PE for writing into a memory (e.g., the local memory 340) by a drain module, e.g., the drain module 370 in FIG. 3.

In some embodiments, one or more restrictions may be imposed on the data loading schedule for reducing the overall implementation complexity for realizing the flexible DNN accelerator. An example restriction in the outer loop of the DNN schedule is that ICs should be loaded as the innermost dimension so that there is no offloading, spilling, and loading of partial sums in the DNN accelerator. Such a restriction may be needed when the PE array has column-wise adder trees. This may remove some additional processing of input data in the DNN accelerator. The load and drain modules of the DNN accelerator may be simplified given the reduced implementation complexity.

In the embodiments of FIG. 6, the loop order is OX first, then OY, and last OC. For the OX dimension. The loop partitioning parameter is 2 for the OX dimension, 7 for the OY dimension, and 16 for the OC dimension. The loop blocking parameter is 7 for the OX dimension, 2 for the OY dimension, and 16 for the OC dimension. In other embodiments, the loop order, loop partition parameters, or loop locking parameters may be different for being tailor to different deep learning operations, such as deep learning operations have input tensor or filter of different sizes.

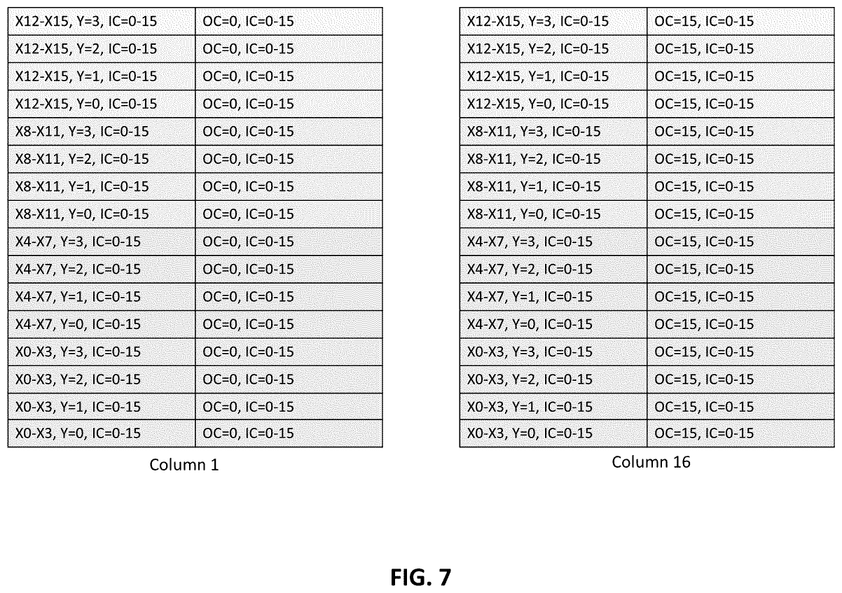

FIG. 7 illustrates a data loading schedule, in accordance with various embodiments. The loading schedule has a loop order of OX, OY, OC, and IC. The looping blocking parameters are 4 for OX, 1 for Oy, 4 for OC, and 16 for IC. The looping partitioning parameters are 4 for OX, 4 for OY, 16 for OC, and 1 for IC. The data loading schedule can allow the activations and weights in the IC dimension to be stored sequentially. This layout can enable easy exploitation of sparse compression in the IC dimension that is performed to achieve compute acceleration during MAC operations across ICs within the PE array.

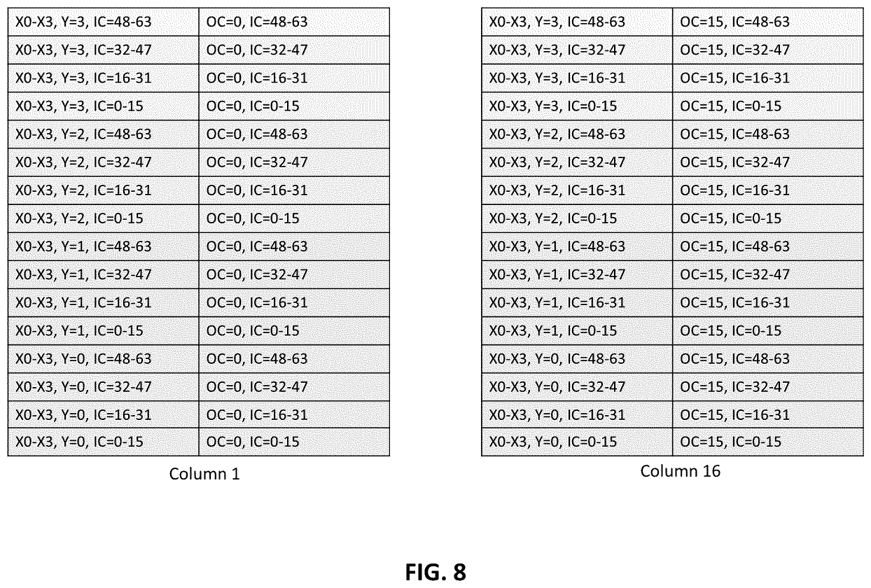

FIG. 8 illustrates another data loading schedule, in accordance with various embodiments. The data loading schedule in FIG. 8 is different from the data loading schedule in FIG. 7. In the embodiments of FIG. 8, the loop order is OX, OY, OC, and IC. The looping blocking parameters are 4 for OX, 1 for Oy, 4 for OC, and 16 for IC. Even though the loop order and loop blocking parameters are the same as the data loading schedule in FIG. 7, but the looping partitioning parameters are different. In the embodiments of FIG. 8, the looping partitioning parameters are 1 for OX, 4 for OY, 16 for OC, and 4 for IC.

In some embodiments, the two different schedules in FIGS. 7 and 8 may be for performing two DNN layers, such as two convolutional layers. In other embodiments, the two different schedules in FIGS. 7 and 8 may be for performing the same DNN layer at different times, e.g., in different inference processes. Compared with the data loading schedule in FIG. 7, the data loading schedule in FIG. 8 can enable better utilization of the PEs for deep learning operations with more input channels. For the purpose of simplicity, each of FIG. 7 and FIG. 8 shows layouts of data to be loaded to two PE columns: the first PE column and the sixteenth PE column in the PE array. Data would be loaded to other PE columns too.

Example Drain Module

FIG. 9 is a block diagram of a drain module 900, in accordance with various embodiments. The drain module 900 extracts output activations computed by PE arrays (e.g., the PE array 380, 400, or 600) and writes the output activations into memories (e.g., the local memory 340). The drain module 900 may be an example of the drain module 370 in FIG. 3. As shown in FIG. 9, the drain module 900 includes local drain modules 910 (individually referred to as “local drain module 910”), group buffers 920 (individually referred to as “group buffer 920”), collection concatenators 930 (individually referred to as “collection concatenator 930”), collection buffers 940 (individually referred to as “collection buffer 940”), a post processing unit 950, a global drain module 960, a sparsity encoder 970, a write module 980, a write buffer 990, and a write module 995. In other embodiments, alternative configurations, different or additional components may be included in the drain module 900. For instance, the drain module 900 may include more than one sparsity encoder or more than one write buffer. Further, functionality attributed to a component of the drain module 900 may be accomplished by a different component included in the drain module 900 or a different module or system.

The local drain modules 910 extract outputs of PEs. In some embodiments, a local drain module 910 may extract an output activation from the output register file of a PE and write the output activation into a group buffer 920. The group buffer 920 may also store, in addition to the output activation, one or more other output activations extracted from output register files of other PEs. The workload of extracting outputs of a PE array may be distributed to multiple local drain modules 910. For instance, each local drain module 910 may drain data from a different portion of the PE array. The PE array may be partitioned into PE columns. Each PE column may include a sequence of PEs. The PE columns may be associated with respective local drain modules 910 for local data draining, i.e., a local drain module 910 is local to a PE column and drains outputs of the PE column but may not drain outputs of other PE columns.

In some embodiments, a group buffer 920 corresponds to a subset of a PE array. An example subset of a PE array may be a PE column in the PE array. The drain module 900 may have a different group buffer 920 for each PE column. The number of group buffers 920 in the drain module 900 may equal the number of PE columns in the PE array. In some embodiments, the output activations stored in a group buffer 920 may be in sequence, e.g., in a sequence that matches the sequence of the PEs in the PE column. In an example data layout of a group buffer 920, the activation computed by the first PE in the PE column is followed by the activation computed by the second PE in the PE column, then the activation computed by the third PE in the PE column, and so on. Examples of the group buffers 920 may be the column buffers 420 in FIG. 4.

The collection concatenators 930 may retrieve activations from the group buffers 920 and perform concatenations on the activations. In some embodiments, a collection concatenator 930 corresponds to a collection of group buffers 920 (or a collection of local drain modules 910) and concatenate activations stored in the group buffers 920 in the corresponding collection. As an example, a predetermined number of PE columns may constitute a collection. A collection concatenator 930 may concatenate the activations stored in the corresponding group buffers 920. In some embodiments, the collection concatenator 930 may arrange the activations into a vector, where the activations are in a sequence that matches the sequence of the PE columns. For instance, the activations generated in the first PE column of the collection may be arranged before the activations generated in the second PE column of the collection, which is before the activations generated in the third PE column (if any) of the collection, and so on.

Each collection concatenator 930 may correspond to a different collection of PE columns. In some embodiments, all the collections may have the same number of PE columns. In other embodiments, the collections may have different numbers of PE columns. The collection concatenators 930 may output different vectors. The vectors are stored in the collection buffers 940. In some embodiments, the collection concatenators 930 are associated with respective collection buffers 940 so that every collection concatenator 930 can store the concatenated activations in the corresponding collection buffer 940.

The post processing unit 950 processes output activations computed by the PE array. In some embodiments, the post processing unit 950 computes activation functions. The post processing unit 950 may receive output activations computed by the PE array as inputs to the activation functions and changes values of the output activations. Additionally or alternatively, the post processing unit 950 may change values of the output activations by applying a bias on the output activations.

In some embodiments, the post processing unit 950 processes the output activations after the output activations are stored in the group buffers 920 but before the output activations are concatenated by the collection concatenators 930. The post processing unit 950 may retrieve the output activations from the group buffers 920 and write the output activations with changed value back into the group buffers 920 after post processing.

In other embodiments, the post processing unit 950 processes the output activations after the output activations are stored in the collection buffers 940. The post processing unit 950 may retrieve the output activations from the collection buffers 940 and write the output activations with changed value back into the collection buffers 940 after post processing. The post processing unit 950 may not change the layout of the output activations in the group buffers 920 or in the collection buffers 940.

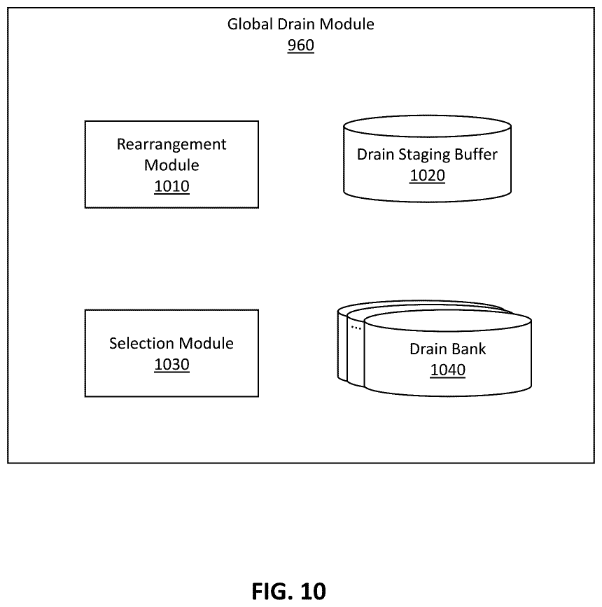

The global drain module 960 receives activations stored in the collection buffers 940 rearranges the activations in 1×1×OC manner. In some embodiments, the global drain module 960 may include a buffer that can store the activations from the collection buffers 940. The data layout in the buffer of the global drain module 960 may be different from the data layouts of the collection buffers 940. For instance, the activations may be stored in a matrix manner, wherein each row of the matrix may store activations generated by PEs in the same PE row of the PE array. The layout of the activations may further be reconstructed. In the reconstructed layout, a group of activations having the same (OX, OY) coordinate may be grouped together to constitute an activation vector. The activations in the same activation vector may be in different output channels from each other. The number of such activation vectors may be equal to the number of output channels of the deep learning operation. Certain aspects of the global drain module 960 are described below in conjunction with FIG. 10.

The sparsity encoder 970 converts dense data to compressed data based on sparsity in the dense data. In some embodiments, the sparsity encoder 970 may receive output activations (e.g., the output tensor 230 in FIG. 2) of a layer, e.g., from the global drain module 960. The output activations may be arranged in activation vectors. The sparsity encoder 970 may generate a compressed version of one or more activation vectors. In some embodiments, the sparsity encoder 970 may compress an activation vector based on an activation threshold. The sparsity encoder 970 may compare the absolute value of each activation with the activation threshold. The sparsity encoder 970 may remove any activations whose absolute value is no greater than the activation threshold from the activation vector to generate a compressed activation vector. The activation threshold may be zero. The removed activations may not be stored in the write buffer 990 or the local memory to save bandwidth and memory usage.

In some embodiments, the sparsity encoder 970 may also generate one or more sparsity tensors of the activation vector. The sparsity tensor may include sparsity elements, each of which corresponds to a different activation in the activation vector and indicates whether the corresponding activation is removed or not. In some embodiments, the sparsity tensor may be a sparsity bitmap, and a sparsity element in the sparsity bitmap may be a bit. A zero bit may indicate that the corresponding activation is removed and not in the compressed activation vector, while a one bit may indicate that the corresponding activation is not removed and is in the compressed activation vector.

In some embodiments, the sparse encoder 970 may encoding sparsity on a context level. A context may be a portion of the output tensor generated by the PE array. In an example, the context may be an activation vector including activations that have the same (X, Y) coordinate but different Z coordinates. The context may be processed in the next DNN layer, e.g., by one or more PEs. For a given context, the sparse encoder 970 may read in multiple lines from a data bank before emitting a single line of N bytes (where N is an integer, such as 16, 32, 64, etc.), depending on the sparsity level. As the elements in a context stream may come over multiple rounds, the sparse encoder 970 can save data indicating a state of the context (“context state”) in a buffer and retrieve the context state back later from the buffer. A context state may include the compressed context, sparsity tensor of the context, activations in the compressed context, and line counts.

In some embodiments, the compressed context and sparsity tensor may be emitted for every N bytes, and the context state may include incomplete lines for the compressed context and sparsity tensor. The sparse encoder 970 may use a context ID to identify a context. The sparse encoder 970 may emit the compressed context and sparsity tensor to a request queue. When the downstream packing logic is ready to process the next request, it will dequeue a request from the request queue and send it to a tensor translation lookup buffer (TTLB) 975 for lookup. In some embodiments, (e.g., embodiment where the drain module 900 includes multiple sparse encoders 970), each sparse encoder 970 may have access to a lookup buffer through the queue. The TTLB 975 may include a predetermined number of translation lookup buffers. In some embodiments, the number of translation lookup buffers in the TTLB 975 may equal the number of bytes in a context. Each translation lookup buffer may track a (X, Y) coordinate for the given drain round.

The TTLB 975 can translate a context ID to an activation coordinate, such as the (X, Y) coordinate of the activations compressed by the sparse encoder 970. coordinate. A context ID with the line count is sent along with the data for the lookup buffer to consume, which is used to know which (X, Y) context the beat is for and what memory offset to write to. Each translation lookup buffer may be programmed with an initial 4-bit X and 4-bit Y value during the configuration phase of the translation lookup buffer. The translation lookup buffer may also be programmed with an X increment and a Y increment and a counter for the total number of X outer rounds and total number of Y outer rounds. After each drain round, the X and Y may be self-updated by the translation lookup buffer based on the IXB*IXP (X increment) for the X and IYB*IYP (Y increment) for Y and the internal X and Y rounds are updated accordingly. The translation lookup buffer may increment the round counters in the X dimension (OXO) first and when it reaches the counter limit as programmed, it will reset the X round count to 0 and increment the Y round counter. In some embodiments, the end of a drain round may be signaled by the sparse encoder 970, which triggers the internal X and Y updates.

In some embodiments, the sparse encoder 970 may recognize the end of the context by keeping track of the output channels based on the sparsity tensor beat count and a comparison of the current sparsity tensor position with a configuration register. The configuration register may be provided by the DNN module 301. When the sparse encoder 970 sends the last beat of compressed context/sparsity tensor to the queue/lookup buffer, the sparse encoder 970 may provide information indicating that this is the last beat to the queue. Any subsequent input data with the same context ID would be ignored till there is new information indicating a new context.

The write module 980 determines memory addresses of output activations and writes the output activations into a memory based on the memory addresses. An example of the memory may be the local memory 340. In some embodiments, the write module 980 determines memory address of activations in the compressed activation vectors. The write module 980 may avoid the determination of memory addresses for activations removed by the sparsity encoder 970. The write module 980 may use the position of an activation in the output tensor of the deep learning operation to generate a memory address for the activation. For instance, the write module 980 may compute the 3D coordinate (e.g., a (OX, OY, OC) coordinate) of the activation. The write module 980 may identify the location of any (OX, OY, OC) coordinate of the output tensor in the memory.

In some embodiments (e.g., embodiments where the sparsity encoder 970 compresses the output tensor), the write module 980 may write compressed activation vectors generated by the sparsity encoder 970 into the memory. The write module 980 may skip activations removed by the sparsity encoder 970 in the compression process. The write module 980 may also write sparsity tensors generated by the sparsity encoder 970 into the memory or a separate memory. In some embodiments, the write module 980 may determine memory addresses of sparsity tensors associated with the output tensor and write the sparsity tensors to the memory based on the memory addresses.

To write an activation vector or sparsity tensor into the memory, the write module 980 may generate a write request that includes the memory address(se) of the activation vector or sparsity tensor and transmit the write request to the memory. The memory, after receiving the write request, may process the write request and store the activation vector or sparsity tensor in one or more data write operations. The write buffer 990 may store the activation vector, sparsity tensor, or the write request while the write request or one or more previous write requests are being processed by the memory.

FIG. 10 is a block diagram of the global drain module 960, in accordance with various embodiments. The global drain module 960 includes a rearrangement module 1010, a drain staging buffer 1020, a selection module 1030, and drain banks 1040 (individually referred to as “drain bank 1040”). In other embodiments, alternative configurations, different or additional components may be included in the global drain module 960. Further, functionality attributed to a component of the global drain module 960 may be accomplished by a different component included in the global drain module 960 or a different module or system.

The rearrangement module 1010 receives activations stored in the collection buffers 940 and rearranges the activations. In some embodiments, the rearrangement module 1010 may perform a number of rearranging operations. In each rearrange cycle, rearrangement module 1010 may retrieve one activation from each of the collection buffers 940. The rearrangement module 1010 may put the activations retrieved in the cycle in a row of activations. In another rearranging operation, the rearrangement module 1010 may form another row of activation that includes activations retrieved from the collection buffer 940. The rearranging operations may be in a sequence of cycles. For instance, the rearrangement module 1010 may retrieve the first activation in each collection buffer 940 in the first cycle, retrieve the second activation in each collection buffer 940 in the second cycle, and so on.

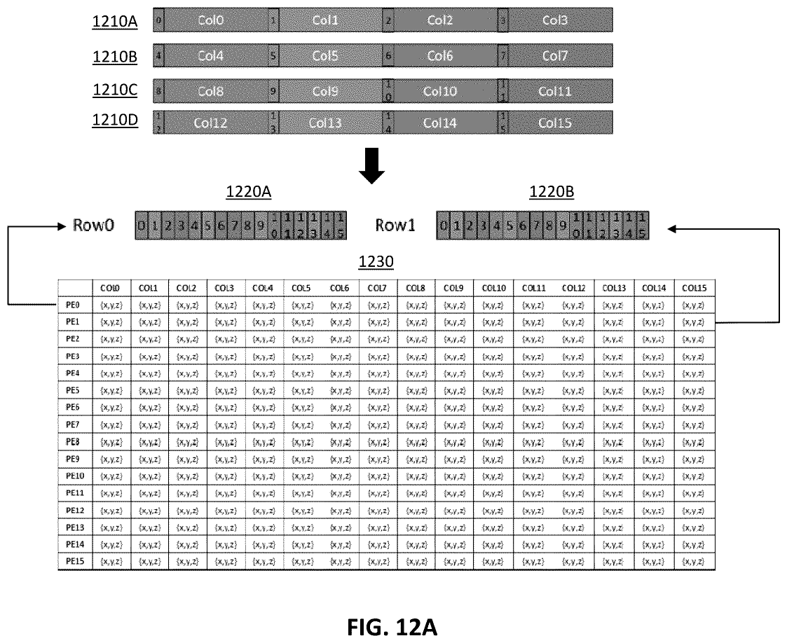

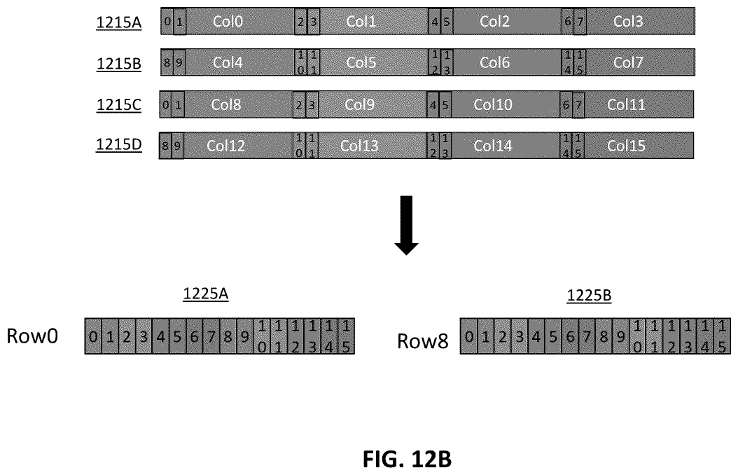

As the rearranging operations are done, the rearrangement module 1010 may generate a matrix of activations. The rows of the matrix may be generated in different rearranging operations. In some embodiments (e.g., embodiments where a collection buffer 940 stores activations from a collection of PE columns), a row of the matrix may include activations generated by a PE row in the PE array, a column of the matrix may include activation generated by a PE column in the PE array. The rearrangement module 1010 may write the matrix into the drain staging buffer 1020. The data layout of the drain staging buffer 1020 may match the distribution of activations in the matrix. Certain aspects of rearranging activations are described below in conjunction with FIG. 12.

The selection module 1030 selects activations stored in the drain staging buffer 1020 in a 1×1×OC manner. In some embodiments, the selection module 1030 selects one of a predetermined number of entries of the drain staging buffer 1020. The predetermined number may be the number of PEs in a PE column. In other embodiments, the selection module 1030 may select a predetermined amount of data, e.g., 16 bytes, 32 bytes, and so on. After the entries are selected, the selection module 1030 may select one or more drain banks 1040 and multicast the selected entries to the selected drain banks(s) 1040. In an example, the global drain module 960 may have 16 drain banks 1040 in four groups. Each group may include 4 drain banks 1040. The selection module 1030 may assign the right rotate value specific to each drain bank 1040 to align and concatenate the consecutive OCs in a single drain bank 1040. The selection module 1030 may further write the correct set of bytes in the selected line of the drain staging buffer 1020 to the drain bank 1040.

In some embodiments, a single drain bank 1040 may store an activation vector including activations having the same (OX, OY) coordinate but different OCs. The activations of the activation vector may be arranged in sequence in accordance with their OCs. For instance, the OC coordinate of the first activation in the activation vector may be in 0, the OC coordinate of the second activation may be in 1, the OC coordinate of the third activation may be in 2, and so on. Different drain banks 1040 may store different activation vectors. The activations in different drain banks 1040 may have different OX coordinates or different OY coordinates.

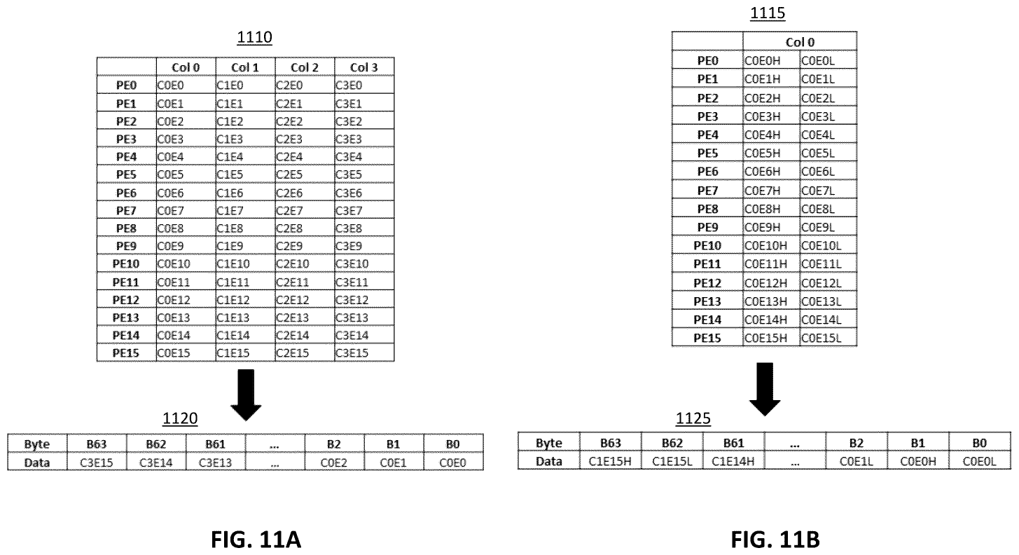

FIGS. 11A and 11B illustrate concatenations of PE outputs, in accordance with various embodiments. The concatenations may be performed by a collection concatenator 930 in FIG. 9. The collection concatenator 930 may have multiple operation modes. For instance, the collection concatenator 930 may operate in an integer mode when the PE outputs are integers but operate in a floating-number mode when the PE outputs are floating numbers. In some embodiments, the collection concatenator 930 may select its operation mode based on the data format of the PE outputs. For instance, the collection concatenator 930 may have an INT8 mode, an FP16 mode, a BF16 mode, and so on. In some embodiments, operation modes of the collection concatenator 930 may be selected using a configuration register bit.

In FIG. 11A, a concatenation is performed on the outputs of four PE columns that are denoted as Col0-Col3. The four PE columns constitute a collection. For the purpose of illustration and simplicity, each PE column includes 16 PEs: PE0-PE15. In other embodiments, there may be a different number of PEs in a PE column or a different number of PE columns in the collection.

The activations have a data layout 1110, which is shown as a matrix with four columns and 16 rows. The activation computed by each PE is denoted as CMEN, where M and N are numbers between 0 and 15, CM indicates which the column index of the PE, and EN indicates the row index of the PE. Each column of the data layout 1110 may be a layout in a group buffer 920. The concatenation converts the data layout 1110 into a different data layout 1120, which has one dimension and is shown as a vector in FIG. 11A. The data layout 1120 starts with the 16 activations computed in the first PE column (Col0), followed by the 16 activations computed in the second PE column (Col1), further followed by the 16 activations computed in the third PE column (Col2), and ends with the 16 activations computed in the fourth PE column (Col3). The data layout 1120 may be a layout in a collection buffer 940.

The activations in FIG. 11A may be in an integer format, such as INT8. Each activation may have a storage size of 1 byte. Different from FIG. 11A, the activations in FIG. 11B may be in a floating-point format, such as FP16, BP16, and so on. Each activation in FIG. 11B may have a storage size of 2 bytes with one byte for the higher bits and another byte for the lower bits. For the purpose of simplicity, FIG. 11B shows the output of a single PE column: Col0, which has 16 PEs: PE0-PE15. The outputs of the PE column have a data layout 1115, which may be a data layout in a group buffer 920. The data layout 1115 has two columns: a column for the higher bits of the activations, and another column for the lower bits of the activations. The collection concatenator 930 concatenates the activations and generates a data layout 1125. The data layout 1125 is shown as a vector with one dimension. The two byes of each activation are processed as one piece during the concatenation and are next to each other in the data layout 1125. The data layout 1125 starts with the two bytes of the activation from the first PE (PE0), followed by the two bytes of the activation from the second PE (PE1), further followed by the two bytes of the activation from the third PE (PE2) till the two bytes of the activation from the sixteenth PE (PE15). The data layout 1125 may be a layout in a collection buffer 940. The data layouts 1120 and 1125 can facilitate the global drain module 960 to retrieve the activations and write the activations into the drain staging buffer 1020.

FIGS. 12A and 12B illustrate rearrangement of activations generated by a from a collection of PE columns, in accordance with various embodiments. The rearrangement may be performed by the rearrangement module 1010 in the global drain module 960. The rearrangement module 1010 can facilitate rearrangement of activations in various data formats, such as INT8, FP16, BF16, and so on. FIG. 12A shows rearrangement of activations having the INT8 format, and FIG. 12B shows rearrangement of activations having the FP16 format. In other embodiments, the rearrangement module 1010 can rearrange activations in other data formats.

FIG. 12A shows four data layouts 1210A-1210D for four collection buffers 940 respectively. The data layouts 1210A-1210D are collectively referred to as “data layouts 1210” or “data layout 1210.” Each data layout 1210 shows activations generated by four PE columns: Col0-Col3. The layout 1210 has a sequence of four groups of activations: the first group is activations generated by the first PE column Col0, the first group is activations generated by the second PE column Col1, the third group is activations generated by the third PE column Col2, and the fourth group is activations generated by the fourth PE column Col3. The number of activations in each group may equal the number of PEs in a single PE column. As the activations are in INT8 format, each activation may have a storage size of 1 byte. For the purpose of simplicity and illustration, FIG. 12A shows the first byte in all the groups in each data layout 1210. These bytes are represented by numbers 0-15, which indicate the sequence in which the activations would be extracted in the rearranging process.

The rearrangement converts the four data layouts 1210 into a new data layout 1230, which is shown as a matrix with rows and columns. The data layout 1230 may be data layout in the drain staging buffer 1020 in FIG. 10. During the rearranging process, the rearrangement module 1010 may take the first byte in each group of each data layout 1210 and add these bytes into a row. The bytes may be added to the row sequentially, starting with the four bytes from the data layout 1210A, then the four bytes from the data layout 1210B, followed by the four bytes from the data layout 1210C, and ends with the four bytes from the data layout 1210D. The four bytes from each data layout 1210 are in a sequence matching the sequence of their corresponding groups in the data layout 1210. As shown in FIG. 12A, each row in the data layout 1230 includes activations generated by PEs in the same PE row, and these PEs are in different PE columns. Each column in the data layout 1230 includes activations generated by PEs in the same PE column.

FIG. 12A shows the first row (Row0) and the second row (Row1) in the data layout 1230. The first row has a data layout 1220A, which includes the first activation in all the groups in the four data layouts 1210. The second row has a data layout 1220B, which includes the second activation in all the groups in the four data layouts 1210. The size of each row in the data layout 1230 would be 16 bytes. In the embodiments of FIG. 12A, the drain staging buffer 1020 has 256 bytes. In other embodiments, the drain staging buffer 1020 may have a different size.

FIG. 12B shows four data layouts 1215A-1215D for four collection buffers 940 respectively. The data layouts 1215A-1215D are collectively referred to as “data layouts 1215” or “data layout 1215.” Each data layout 1215 shows activations generated by four PE columns: Col0-Col3. The layout 1215 has a sequence of four groups of activations: the first group is activations generated by the first PE column Col0, the first group is activations generated by the second PE column Col1, the third group is activations generated by the third PE column Col2, and the fourth group is activations generated by the fourth PE column Col3. The number of activations in each group may equal the number of PEs in a single PE column. As the activations are in FP16 format, each activation may have a storage size of 2 bytes. For the purpose of simplicity and illustration, FIG. 12B shows the first two bytes in all the groups in each data layout 1215. These bytes are represented by numbers 0-15, which indicate the sequence in which bytes would be extracted in the rearranging process.

The rearrangement module 1010 may take two bytes from each group in each data layout 1215 at a time. The two bytes for a single activation may be processed as one chunk. The rearrangement module 1010 may further write the bytes into the drain staging buffer 1020. For the purpose of simplicity and illustration, FIG. 12B shows the first two rows 1225A and 1225B of the data layout in the drain staging buffer 1020. Each row has 16 bytes for 8 activations.

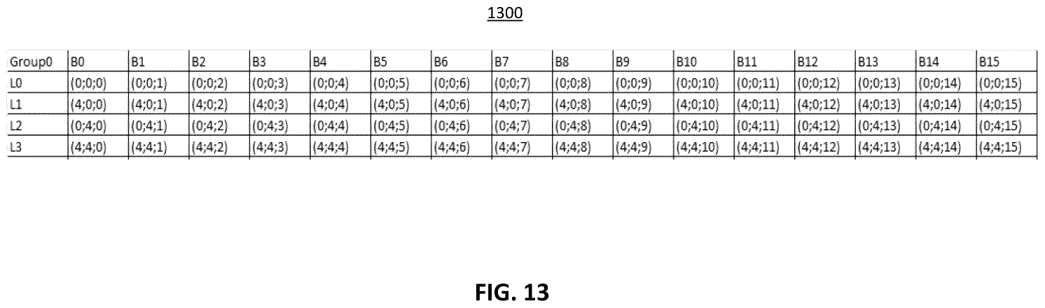

FIG. 13 illustrates a data layout 1300 in a drain bank 1040 of the global drain module 960, in accordance with various embodiments. The data layout 1300 may be determined by the selection module 1030 of the global drain module 960. For the purpose of illustration, FIG. 13 shows a single group (Group0) of 64 bytes stored in the drain bank 1040, and the 64 activations are in 4 lines (L0-L3). Each line stores 16 bytes. In other embodiments, the drain bank 1040 may have fewer or more lines or bytes.

The selection module 1030 groups activations having the same (X, Y) coordinate together. For instance, the first line L0 includes activations whose (X, Y) coordinates are all (0, 0), the second line L1 includes activations whose (X, Y) coordinates are all (4, 0), the third line L2 includes activations whose (X, Y) coordinates are all (0, 4), the fourth line L3 includes activations whose (X, Y) coordinates are all (4, 4). Each line has 16 activations, which have different z coordinates from each other, indicating that the activations are in different output channels from each other.

In some embodiments, the group of the activations in the drain bank 1040 may depend on the order in which the activations are drained from the PE array. In an embodiment, within a single PE column, the activations may be produced in OY, OX, OC order from the first PE to the last PE. In some embodiments, the groups of activations may be fixed for other layers. The activations in FIG. 13 may have INT8 format. For activations in other data format, a single activation may have more bytes and all the bytes may be contained within a single line of the drain bank 1040. For activations in FP16 format, the number of activations stored in a line would be halved as a single FP16 data point would need two bytes.

The activations stored in the drain bank 1040 may be further processed, e.g., in a compression process, etc. The order of the activations in memory would remain the same despite the additional processing. Some or all the activations would be written into another memory for performing additional deep learning operations.

FIG. 14 illustrates an example implementation of a drain module 1400, in accordance with various embodiments. The drain module 1400 may be an example of the drain module 370 in FIG. 3. The drain module 1400 includes local drain modules 1410A-1410P (collectively referred to as “local drain modules 1410” or “local drain module 1410”) associated with buffers 1420A-1420P collectively referred to as (“buffers 1420” or “buffer 1420”), collection concatenators 1430A-1420D (collectively referred to as “collection concatenators 1430” or “collection concatenator 1430”), a data transfer path 1440, a global drain module 1450, and a memory 1460. In other embodiments, the drain module 1400 may include fewer, more, or different components. For instance, the drain module 1400 may include a different number of local drain modules 1410, buffers 1420, or collection concatenators 1430.

Each local drain module 1410 may drain outputs of PEs in the same PE column of a PE array. The PE array may be an example of the PE array 360 in FIG. 3. The drained outputs are stored in the buffer 1420 associated with the local drain module 1410. Examples of the buffer 1420 may be the column buffers 420 in FIG. 4. Each buffer 1420 may store a portion of an output tensor of a convolution.

Four local drain modules 1410 are grouped together and associated with a collection concatenator 1430. There are four collection concatenators 1430 in FIG. 14. Each collection concatenator 1430 concatenators activations in the four buffers 1420. Taking the collection concatenator 1430A for example, the collection concatenator 1430 may form a sequence of activations, which starts with the activations in the buffer 1420A, followed by the activations in the buffer 1420B, further followed by the activation in the buffer 1420C, and ends with the activation in the buffer 1420D. The sequence of the activations from each buffer 1420 may not change in the concatenation process. After the concatenation process, each collection concatenator 1430 sends the activations to the global drain module 1450 through the data transfer path 1440. In some embodiments, the data transfer path 1440 may include or be associated with a network on chip that facilitates data transfer from the collection concatenators 1430 to the global drain module 1450.

The global drain module 1450 further combines and reconstruct the layout of the activations from the collection concatenators 1430. For instance, the global drain module 1450 may shuffle and reorder the activations so that activations with the same (X, Y) coordinate are grouped together. The activations may be written into the memory 1460 with the new layout determined by the global drain module. The memory 1460 may be a group of drain banks 9 e.g., drain banks 1040) or a memory associated with the PE array (e.g., the local memory 340).

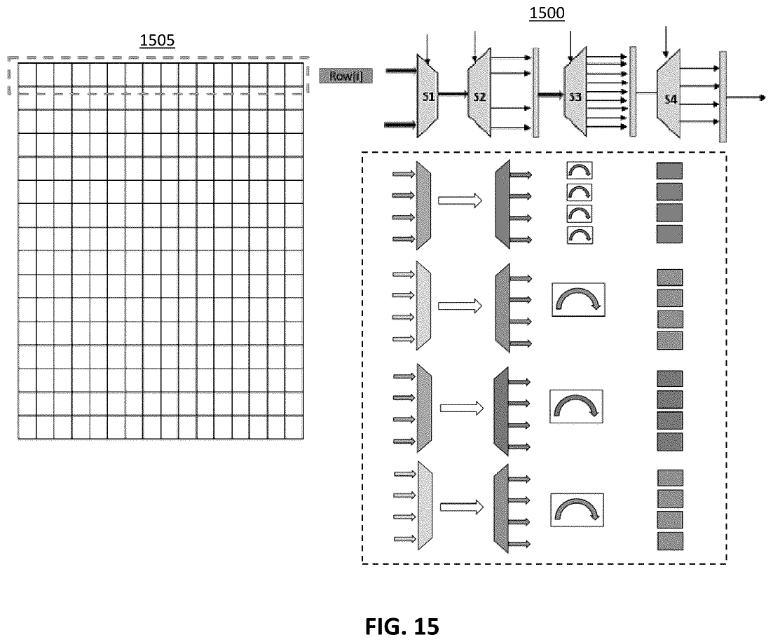

FIG. 15 illustrates an example MUX network 1500, in accordance with various embodiments. The MUX network 1500 may select data points from a storage unit 1505 and reconstruct the layout of the data points in a 1×1×OC manner. The storage unit 1505 may be an example of the drain staging buffer 1020 in FIG. 10. The MUX network 1500 may be an example implementation of the selection module 1030 in FIG. 10.

The MUX network 1500 may operate in four stages, shown as S1-S4 in FIG. 15. Each stage may be performed by one or more MUXs in the MUX network 1500. In S1, one or more MUXs may select a predetermined number of bytes from the storage unit 1505. In some embodiments, the one or more MUXs may select the bytes in a row-wise manner. For instance, the storage unit 1505 includes 16 rows. The one or more MUXs may include a 16:1 MUX that can select a single row from the 16 rows. The selected row is denoted as Row[i] in FIG. 15. A row in the storage unit 1505 may be referred to as an entry, and S1 may also be referred to as an entry selection stage.

In S2, drain banks (e.g., drain banks 1040) are organized into groups. Each group may have a predetermined number of entries. In an example, a single data bank may be able to store M entries, a group with N data banks can store M×N entries, where M and N are integers. This stage can identify which of the 16 entries in the storage unit 1505 would be written into which data bank, which can ensure proper multicasting of the data to the data bank(s). The data bank(s) for the selected entry are enabled to be ready for S3. S2 may also be referred to as a bank selection stage.

In S3, the selected entry (i.e., Row[i]) in the storage unit 1505 is multicast to the corresponding, enabled data bank(s). Also, S3 includes right rotations of the selected entry. The right rotations are represented by the curved arrows in FIG. 15. A right-rotation value may be determined for a data bank. The right-rotation value may indicate the amount of rotation to be performed on the selected entry. The right-rotation value may be specific to the data bank and be different from right-rotation values of other data banks. An approximate right-rotation value would ensure that the activations with the same (X, Y) coordinates and consecutive z coordinates are aligned in the data bank. This stage may also be referred to as the right-rotation stage. As described above, the order of the activations drained from the PE array may be flexible as the schedules for loading data into the PE array can be flexible and different for different DNN layers or different DNNs. With the appropriate right-rotation, the order of the activations can be uniformized. The right-rotation values for different convolutions may be different.

In S4, the bytes in the selected entry are written into the corresponding data bank(s). This stage may also be referred to as byte enablement stage as the bytes are enabled for write.

Example DNN Module

FIG. 16 is a block diagram of a DNN module 1600, in accordance with various embodiments. The DNN module 1600 may be an embodiment of the DNN module 301 in FIG. 3. As shown in FIG. 16, the DNN module 1600 includes an interface module 1610, a training module 1620, a compressing module 1630, a validating module 1640, and a datastore 1650. In other embodiments, alternative configurations, different or additional components may be included in the DNN module 1600. Further, functionality attributed to a component of the DNN module 1600 may be accomplished by a different component included in the DNN module 1600 or a different module or system.

The interface module 1610 facilitates communications of the DNN module 1600 with other modules or systems. For example, the interface module 1610 establishes communications between the DNN module 1600 with an external database to receive data that can be used to train DNNs or input into DNNs to perform tasks. As another example, the interface module 1610 supports the DNN module 1600 to distribute DNNs to other systems, e.g., computing devices configured to apply DNNs to perform tasks.

The training module 1620 trains DNNs by using a training dataset. The training module 1620 forms the training dataset. In an embodiment where the training module 1620 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validating module 1640 to validate performance of a trained DNN. The portion of the training dataset not including the tuning subset and the validation subset may be used to train the DNN.

The training module 1620 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 5, 10, 50, 100, 500, 1000, or even larger.

The training module 1620 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, SoftMax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between two convolution layers. A fully connected layer involves weights, biases, and neurons. It connects neurons in one layer to neurons in another layer. It is used to classify images between different category by training.

In the process of defining the architecture of the DNN, the training module 1620 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 1620 defines the architecture of the DNN, the training module 1620 inputs a training dataset into the DNN. The training dataset includes a plurality of training samples. An example of a training sample includes an object in an image and a ground-truth label of the object. The training module 1620 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 1620 uses a cost function to minimize the error.

The training module 1620 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 1620 finishes the predetermined number of epochs, the training module 1620 may stop updating the parameters in the DNN. The DNN having the updated parameters is referred to as a trained DNN.

The compressing module 1630 compresses DNNs. For instance, the compressing module 1630 may add pruning operations to DNN layers to reduce computational complexity or memory usage. A pruning operation may prune weight tensors of a DNN layer by changing one or more nonzero valued weights of the layer to zeros. The modification may be done before, during, or after training. Weights may be pruned during training, during inference, or a combination of both. The compressing module 1630 may determine a sparsity ratio for a DNN layer. The sparsity ratio may be a ratio of the number of zero-valued weights to the total number of weights in the layer. The compressing module 1630 may perform the pruning operation till the sparsity ratio of the DNN layer meets a target sparsity ration, such as 10%, 20%, 30%, 160%, 50%, and so on.

In some embodiments, the compressing module 1630 may select one or more layers in a DNN and modify each selected layer with a pruning operation. For instance, the compressing module 1630 may select computationally complex layers, such as layers with large filters. For a pruning operation of a layer or of a type of layer, the compressing module 1630 may determine a weight threshold that would not cause a loss of the accuracy of the DNN to exceed an accuracy loss constraint. A pruning operation may modify weights having absolute values above the weight threshold to zeros and leave the other weights unchanged. The weight pruning can reduce memory storage as zero-valued weights may not be stored. Also, the number of operations in the layer can be reduced as computations on zero-valued weights can be skipped without impacting the output of the layer. In some embodiments, the compressing module 1630 may also measure energy saving, final DNN accuracy, or layer-wise sparsity caused by pruning operations.

After compressing a DNN, the compressing module 1630 may fine tune the DNN, e.g., through a retraining process. The compressing module 1630 may fine tunes DNNs after weights are pruned. In some embodiments, the fine-tuning process is a retraining or further training process. For instance, after weights in a DNN are pruned, the compressing module 1630 may further train the DNN by inputting a training dataset into the DNN. The values of the unpruned weights in the DNN may be modified based on outputs of the DNN and ground-truth labels of the training samples in the training dataset. In some embodiments, the values of the pruned weights (i.e., zero) are not changed during the fine-tuning process. For instance, the compressing module 1630 may place a mask over a pruned weight block and the mask can prevent values in the pruned weight blocks from being changed during the fine-tuning process. In other embodiments, the values of all weights, including the pruned weights, may be changed during the fine-tuning process. After one or more cycles of retraining and weight changing by the compressing module 1630, the compressing module 1630 may perform a new pruning process, e.g., by selecting weight blocks and pruning the selected weight blocks. In some embodiments, the weight pruning process may be repeated multiple times before the fine-tuning process is done.

In some embodiments, the number of epochs in the fine-tuning process may be different from the number of epochs in the training process in which the pre-pruning values of the weights are determined. For instance, the fine-tuning process may have less epochs than the training process. In an example, the number of epochs in the fine-tuning process may be relatively small, such as 2, 3, 16, 5, and so on.

The validating module 1640 verifies accuracy of trained or compressed DNNs. In some embodiments, the validating module 1640 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validating module 1640 may determine an accuracy score measuring the precision, recall, or a combination of precision and recall of the DNN. The validating module 1640 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validating module 1640 may compare the accuracy score with a threshold score. In an example where the validating module 1640 determines that the accuracy score of the augmented model is less than the threshold score, the validating module 1640 instructs the training module 1620 to re-train the DNN. In one embodiment, the training module 1620 may iteratively re-train the DNN until the occurrence of a stopping condition, such as the accuracy measurement indication that the DNN may be sufficiently accurate, or a number of training rounds having taken place.

The datastore 1650 stores data received, generated, used, or otherwise associated with the DNN module 1600. For example, the datastore 1650 stores the datasets used by the training module 1620 and validating module 1640. The datastore 1650 may also store data generated by the training module 1620 and validating module 1640, such as the hyperparameters for training DNNs, internal parameters of trained DNNs (e.g., weights, etc.), data for sparsity acceleration (e.g., sparsity bitmap, etc.), and so on. The datastore 1650 may store schedules for loading data into the PE array 360. In the embodiment of FIG. 16, the datastore 1650 is a component of the DNN module 1600. In other embodiments, the datastore 1650 may be external to the DNN module 1600 and communicate with the DNN module 1600 through a network.

Example Method of Draining Output Data from PE Array

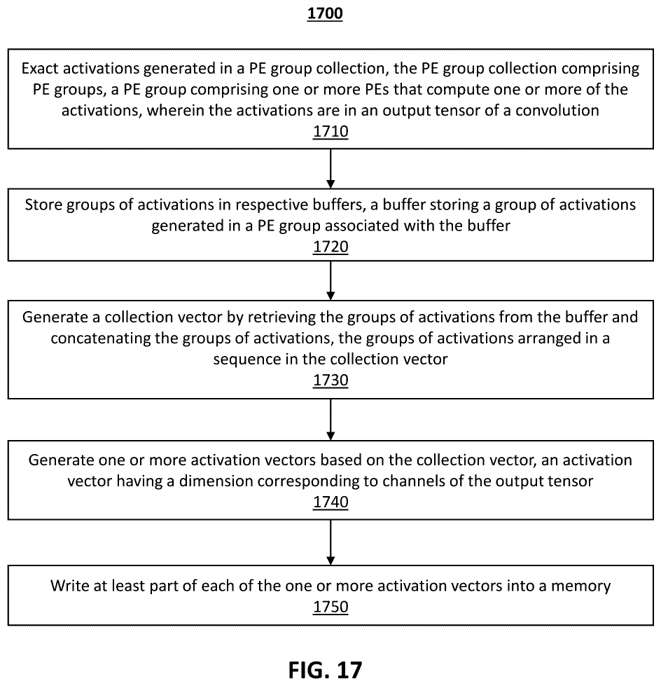

FIG. 17 is a flowchart showing a method 1700 of draining data from a PE array, in accordance with various embodiments. The method 1700 may be performed by the drain module 370 in FIG. 3. Although the method 1700 is described with reference to the flowchart illustrated in FIG. 17, many other methods for draining data from a PE array may alternatively be used. For example, the order of execution of the steps in FIG. 17 may be changed. As another example, some of the steps may be changed, eliminated, or combined.

The drain module 370 extracts 1710 activations generated in a PE group collection. The PE group collection comprises PE groups. A PE group comprises one or more PEs that compute one or more of the activations, wherein the activations are in an output tensor of a convolution.

The drain module 370 stores 1720 groups of activations in respective buffers. A buffer stores a group of activations generated in a PE group associated with the buffer. In some embodiments, the output tensor is generated in a PE array where PEs are arranged in rows and columns. A PE group may be a column in the PE array. A PE group collection may be a subset of the columns in the PE array. The PE array may be divided into a set of PE group collections that include the PE group collection. A buffer is a column buffer and stores outputs of the PEs in the corresponding column.

The drain module 370 generates 1730 a collection vector by retrieving the groups of activations from the buffer and concatenating the groups of activations. The groups of activations are arranged in a sequence in the collection vector. In an example where the PE group collection includes a sequence of PE groups, the activations generated by the first PE group is followed by the activations generated by the second PE group, which is further followed by the activations generated by the third PE group, and so on.

The drain module 370 generates 1740 one or more activation vectors based on the collection vector, an activation vector having a dimension corresponding to channels of the output tensor. A sequence of the activations in the collection vector is different from a sequence of the activations in the one or more activation vectors.

In some embodiments, the drain module 370 generates a global activation tensor by combining the collection vector with one or more additional collection vector. An additional collection vector is generated in another PE group collection. The global activation tensor has the at least two dimensions. The drain module 370 rearranges elements of the global activation tensor to generate the one or more activation vectors. In some embodiments, the global activation tensor comprises rows. A row comprises one or more activations from the collection vector followed by one or more activations from the additional collection vector. In some embodiments, the output tensor is generated in a PE array that includes the PE group collection and the another PE group collection. The row of the global activation tensor comprises activations generated in PEs arranged in the same row of the PE array.

The drain module 370 writes 1750 at least part of each of the one or more activation vectors into a memory. In some embodiments, the drain module 370 determines a three-dimensional coordinate of an activation of the activation vector in the output tensor. The drain module 370 determines a memory address based on the three-dimensional coordinate. The drain module 370 writes the activation into the memory at the memory address.

In some embodiments, the drain module 370 generates a compressed activation vector by removing one or more zero-valued elements from the activation vector. The drain module 370 writes the compressed activation vector into the memory. In some embodiments, the drain module 370 generates a sparsity tensor comprising a plurality of sparsity elements. A sparsity element corresponds to an element of the activation vector and indicates whether the corresponding element is present in the compressed activation vector. The drain module 370 writes the sparsity tensor into the memory.

Example Computing Device

FIG. 18 is a block diagram of an example computing device 1800, in accordance with various embodiments. In some embodiments, the computing device 1800 can be used as at least part of the DNN system 300. A number of components are illustrated in FIG. 18 as included in the computing device 1800, but any one or more of these components may be omitted or duplicated, as suitable for the application. In some embodiments, some or all of the components included in the computing device 1800 may be attached to one or more motherboards. In some embodiments, some or all of these components are fabricated onto a single system on a chip (SoC) die. Additionally, in various embodiments, the computing device 1800 may not include one or more of the components illustrated in FIG. 18, but the computing device 1800 may include interface circuitry for coupling to the one or more components. For example, the computing device 1800 may not include a display device 1806, but may include display device interface circuitry (e.g., a connector and driver circuitry) to which a display device 1806 may be coupled. In another set of examples, the computing device 1800 may not include an audio input device 1818 or an audio output device 1808, but may include audio input or output device interface circuitry (e.g., connectors and supporting circuitry) to which an audio input device 1818 or audio output device 1808 may be coupled.

The computing device 1800 may include a processing device 1802 (e.g., one or more processing devices). The processing device 1802 processes electronic data from registers and/or memory to transform that electronic data into other electronic data that may be stored in registers and/or memory. The computing device 1800 may include a memory 1804, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1804 may include memory that shares a die with the processing device 1802. In some embodiments, the memory 1804 includes one or more non-transitory computer-readable media storing instructions executable to perform operations for accelerating deep learning operations, e.g., the method 1700 described above in conjunction with FIG. 17 or some operations performed by the drain module 370 described above in conjunction with FIG. 3. The instructions stored in the one or more non-transitory computer-readable media may be executed by the processing device 1802.

In some embodiments, the computing device 1800 may include a communication chip 1812 (e.g., one or more communication chips). For example, the communication chip 1812 may be configured for managing wireless communications for the transfer of data to and from the computing device 1800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1812 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1812 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1812 may operate in accordance with other wireless protocols in other embodiments. The computing device 1800 may include an antenna 1822 to facilitate wireless communications and/or to receive other wireless communications (such as AM or FM radio transmissions).

In some embodiments, the communication chip 1812 may manage wired communications, such as electrical, optical, or any other suitable communication protocols (e.g., the Ethernet). As noted above, the communication chip 1812 may include multiple communication chips. For instance, a first communication chip 1812 may be dedicated to shorter-range wireless communications such as Wi-Fi or Bluetooth, and a second communication chip 1812 may be dedicated to longer-range wireless communications such as global positioning system (GPS), EDGE, GPRS, CDMA, WiMAX, LTE, EV-DO, or others. In some embodiments, a first communication chip 1812 may be dedicated to wireless communications, and a second communication chip 1812 may be dedicated to wired communications.

The computing device 1800 may include battery/power circuitry 1814. The battery/power circuitry 1814 may include one or more energy storage devices (e.g., batteries or capacitors) and/or circuitry for coupling components of the computing device 1800 to an energy source separate from the computing device 1800 (e.g., AC line power).

The computing device 1800 may include a display device 1806 (or corresponding interface circuitry, as discussed above). The display device 1806 may include any visual indicators, such as a heads-up display, a computer monitor, a projector, a touchscreen display, a liquid crystal display (LCD), a light-emitting diode display, or a flat panel display, for example.

The computing device 1800 may include an audio output device 1808 (or corresponding interface circuitry, as discussed above). The audio output device 1808 may include any device that generates an audible indicator, such as speakers, headsets, or earbuds, for example.

The computing device 1800 may include an audio input device 1818 (or corresponding interface circuitry, as discussed above). The audio input device 1818 may include any device that generates a signal representative of a sound, such as microphones, microphone arrays, or digital instruments (e.g., instruments having a musical instrument digital interface (MIDI) output).

The computing device 1800 may include a GPS device 1816 (or corresponding interface circuitry, as discussed above). The GPS device 1816 may be in communication with a satellite-based system and may receive a location of the computing device 1800, as known in the art.

The computing device 1800 may include another output device 1810 (or corresponding interface circuitry, as discussed above). Examples of the other output device 1810 may include an audio codec, a video codec, a printer, a wired or wireless transmitter for providing information to other devices, or an additional storage device.

The computing device 1800 may include another input device 1820 (or corresponding interface circuitry, as discussed above). Examples of the other input device 1820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1800 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1800 may be any other electronic device that processes data.

### Select Examples

The following paragraphs provide various examples of the embodiments disclosed herein.
Example 1 provides a method, including extracting activations generated in a PE group collection, the PE group collection including PE groups, a PE group including one or more PEs that compute one or more of the activations, in which the activations are in an output tensor of a convolution; storing groups of activations in respective buffers, a buffer storing a group of activations generated in a PE group associated with the buffer; generating a collection vector by retrieving the groups of activations from the buffer and concatenating the groups of activations, the groups of activations arranged in a sequence in the collection vector; generating one or more activation vectors based on the collection vector, an activation vector having a dimension corresponding to channels of the output tensor, in which a sequence of the activations in the collection vector is different from a sequence of the activations in the one or more activation vectors; and writing at least part of each of the one or more activation vectors into a memory.
Example 2 provides the method of example 1, in which generating the one or more activation vectors includes generating a global activation tensor by combining the collection vector with one or more additional collection vector, an additional collection vector generated in another PE group collection, the global activation tensor having at least two dimensions; and rearranging elements of the global activation tensor to generate the one or more activation vectors.
Example 3 provides the method of example 2, in which the global activation tensor includes rows, and a row includes one or more activations from the collection vector followed by one or more activations from the additional collection vector.
Example 4 provides the method of example 3, in which the output tensor is generated in a PE array that includes the PE group collection and the another PE group collection, and the row of the global activation tensor includes activations generated in PEs arranged in a same row of the PE array.
Example 5 provides the method of any one of examples 1-4, in which writing at least part of each of the one or more activation vectors into the memory includes generating a compressed activation vector by removing one or more zero-valued elements from the activation vector; and writing the compressed activation vector into the memory.
Example 6 provides the method of example 5, further including generating a sparsity tensor including a plurality of sparsity elements, a sparsity element corresponding to an element of the activation vector and indicating whether the corresponding element is present in the compressed activation vector; and writing the sparsity tensor into the memory.
Example 7 provides the method of any one of examples 1-6, further including determining a three-dimensional coordinate of an activation of the activation vector in the output tensor; determining a memory address based on the three-dimensional coordinate; and writing the activation into the memory at the memory address.
Example 8 provides one or more non-transitory computer-readable media storing instructions executable to perform operations, the operations including extracting activations generated in a PE group collection, the PE group collection including PE groups, a PE group including one or more PEs that compute one or more of the activations, in which the activations are in an output tensor of a convolution; storing groups of activations in respective buffers, a buffer storing a group of activations generated in a PE group associated with the buffer; generating a collection vector by retrieving the groups of activations from the buffer and concatenating the groups of activations, the groups of activations arranged in a sequence in the collection vector; generating one or more activation vectors based on the collection vector, an activation vector having a dimension corresponding to channels of the output tensor, in which a sequence of the activations in the collection vector is different from a sequence of the activations in the one or more activation vectors; and writing at least part of each of the one or more activation vectors into a memory.
Example 9 provides the one or more non-transitory computer-readable media of example 8, in which generating the one or more activation vectors includes generating a global activation tensor by combining the collection vector with one or more additional collection vector, an additional collection vector generated in another PE group collection, the global activation tensor having at least two dimensions; and rearranging elements of the global activation tensor to generate the one or more activation vectors.
Example 10 provides the one or more non-transitory computer-readable media of example 9, in which the global activation tensor includes rows, and a row includes one or more activations from the collection vector followed by one or more activations from the additional collection vector.
Example 11 provides the one or more non-transitory computer-readable media of example 10, in which the output tensor is generated in a PE array that includes the PE group collection and the another PE group collection, and the row of the global activation tensor includes activations generated in PEs arranged in a same row of the PE array.
Example 12 provides the one or more non-transitory computer-readable media of any one of examples 8-11, in which writing at least part of each of the one or more activation vectors into the memory includes generating a compressed activation vector by removing one or more zero-valued elements from the activation vector; and writing the compressed activation vector into the memory.
Example 13 provides the one or more non-transitory computer-readable media of example 12, in which the operations further include generating a sparsity tensor including a plurality of sparsity elements, a sparsity element corresponding to an element of the activation vector and indicating whether the corresponding element is present in the compressed activation vector; and writing the sparsity tensor into the memory.
Example 14 provides the one or more non-transitory computer-readable media of any one of examples 8-13, in which the operations further include determining a three-dimensional coordinate of an activation of the activation vector in the output tensor; determining a memory address based on the three-dimensional coordinate; and writing the activation into the memory at the memory address.
Example 15 provides an apparatus, including a computer processor for executing computer program instructions; and a non-transitory computer-readable memory storing computer program instructions executable by the computer processor to perform operations including extracting activations generated in a PE group collection, the PE group collection including PE groups, a PE group including one or more PEs that compute one or more of the activations, in which the activations are in an output tensor of a convolution, storing groups of activations in respective buffers, a buffer storing a group of activations generated in a PE group associated with the buffer; generating a collection vector by retrieving the groups of activations from the buffer and concatenating the groups of activations, the groups of activations arranged in a sequence in the collection vector; generating one or more activation vectors based on the collection vector, an activation vector having a dimension corresponding to channels of the output tensor, in which a sequence of the activations in the collection vector is different from a sequence of the activations in the one or more activation vectors; and writing at least part of each of the one or more activation vectors into a memory.
Example 16 provides the apparatus of example 15, in which generating the one or more activation vectors includes generating a global activation tensor by combining the collection vector with one or more additional collection vector, an additional collection vector generated in another PE group collection, the global activation tensor having at least two dimensions; and rearranging elements of the global activation tensor to generate the one or more activation vectors.
Example 17 provides the apparatus of example 16, in which the global activation tensor includes rows, and a row includes one or more activations from the collection vector followed by one or more activations from the additional collection vector.
Example 18 provides the apparatus of example 17, in which the output tensor is generated in a PE array that includes the PE group collection and the another PE group collection, and the row of the global activation tensor includes activations generated in PEs arranged in a same row of the PE array.
Example 19 provides the apparatus of any one of examples 15-18, in which writing at least part of each of the one or more activation vectors into the memory includes generating a compressed activation vector by removing one or more zero-valued elements from the activation vector; generating a sparsity tensor including a plurality of sparsity elements, a sparsity element corresponding to an element of the activation vector and indicating whether the corresponding element is present in the compressed activation vector; and writing the compressed activation vector and the sparsity tensor into the memory.
Example 20 provides the apparatus of any one of examples 15-19, in which the operations further include determining a three-dimensional coordinate of an activation of the activation vector in the output tensor; determining a memory address based on the three-dimensional coordinate; and writing the activation into the memory at the memory address.

1. A method, comprising:
extracting activations generated in a processing element (PE) group collection, the PE group collection comprising PE groups, a PE group comprising one or more PEs that compute one or more of the activations, wherein the activations are in an output tensor of a convolution;
storing groups of activations in respective buffers, a buffer storing a group of activations generated in a PE group associated with the buffer;
generating a collection vector by retrieving the groups of activations from the buffer and concatenating the groups of activations, the groups of activations arranged in a sequence in the collection vector;
generating one or more activation vectors based on the collection vector, an activation vector having a dimension corresponding to channels of the output tensor, wherein a sequence of the activations in the collection vector is different from a sequence of the activations in the one or more activation vectors; and
writing at least part of each of the one or more activation vectors into a memory.

2. The method of claim 1, wherein generating the one or more activation vectors comprises:
generating a global activation tensor by combining the collection vector with one or more additional collection vector, an additional collection vector generated in another PE group collection, the global activation tensor having at least two dimensions; and
rearranging elements of the global activation tensor to generate the one or more activation vectors.

3. The method of claim 2, wherein the global activation tensor comprises rows, and a row comprises one or more activations from the collection vector followed by one or more activations from the additional collection vector.

4. The method of claim 3, wherein the output tensor is generated in a PE array that includes the PE group collection and the another PE group collection, and the row of the global activation tensor comprises activations generated in PEs arranged in a same row of the PE array.

5. The method of claim 1, wherein writing at least part of each of the one or more activation vectors into the memory comprises:
generating a compressed activation vector by removing one or more zero-valued elements from the activation vector; and
writing the compressed activation vector into the memory.

6. The method of claim 5, further comprising:
generating a sparsity tensor comprising a plurality of sparsity elements, a sparsity element corresponding to an element of the activation vector and indicating whether the corresponding element is present in the compressed activation vector; and
writing the sparsity tensor into the memory.

7. The method of claim 1, further comprising:
determining a three-dimensional coordinate of an activation of the activation vector in the output tensor;
determining a memory address based on the three-dimensional coordinate; and
writing the activation into the memory at the memory address.

8. One or more non-transitory computer-readable media storing instructions executable to perform operations, the operations comprising:
extracting activations generated in a processing element (PE) group collection, the PE group collection comprising PE groups, a PE group comprising one or more PEs that compute one or more of the activations, wherein the activations are in an output tensor of a convolution;
storing groups of activations in respective buffers, a buffer storing a group of activations generated in a PE group associated with the buffer;
generating a collection vector by retrieving the groups of activations from the buffer and concatenating the groups of activations, the groups of activations arranged in a sequence in the collection vector;
generating one or more activation vectors based on the collection vector, an activation vector having a dimension corresponding to channels of the output tensor, wherein a sequence of the activations in the collection vector is different from a sequence of the activations in the one or more activation vectors; and
writing at least part of each of the one or more activation vectors into a memory.

9. The one or more non-transitory computer-readable media of claim 8, wherein generating the one or more activation vectors comprises:
generating a global activation tensor by combining the collection vector with one or more additional collection vector, an additional collection vector generated in another PE group collection, the global activation tensor having at least two dimensions; and
rearranging elements of the global activation tensor to generate the one or more activation vectors.

10. The one or more non-transitory computer-readable media of claim 9, wherein the global activation tensor comprises rows, and a row comprises one or more activations from the collection vector followed by one or more activations from the additional collection vector.

11. The one or more non-transitory computer-readable media of claim 10, wherein the output tensor is generated in a PE array that includes the PE group collection and the another PE group collection, and the row of the global activation tensor comprises activations generated in PEs arranged in a same row of the PE array.

12. The one or more non-transitory computer-readable media of claim 8, wherein writing at least part of each of the one or more activation vectors into the memory comprises:
generating a compressed activation vector by removing one or more zero-valued elements from the activation vector; and
writing the compressed activation vector into the memory.

13. The one or more non-transitory computer-readable media of claim 12, wherein the operations further comprise:
generating a sparsity tensor comprising a plurality of sparsity elements, a sparsity element corresponding to an element of the activation vector and indicating whether the corresponding element is present in the compressed activation vector; and
writing the sparsity tensor into the memory.

14. The one or more non-transitory computer-readable media of claim 8, wherein the operations further comprise:
determining a three-dimensional coordinate of an activation of the activation vector in the output tensor;
determining a memory address based on the three-dimensional coordinate; and
writing the activation into the memory at the memory address.

15. An apparatus, comprising:
a computer processor for executing computer program instructions; and
a non-transitory computer-readable memory storing computer program instructions executable by the computer processor to perform operations comprising:
extracting activations generated in a processing element (PE) group collection, the PE group collection comprising PE groups, a PE group comprising one or more PEs that compute one or more of the activations, wherein the activations are in an output tensor of a convolution,
storing groups of activations in respective buffers, a buffer storing a group of activations generated in a PE group associated with the buffer,
generating a collection vector by retrieving the groups of activations from the buffer and concatenating the groups of activations, the groups of activations arranged in a sequence in the collection vector,
generating one or more activation vectors based on the collection vector, an activation vector having a dimension corresponding to channels of the output tensor, wherein a sequence of the activations in the collection vector is different from a sequence of the activations in the one or more activation vectors, and
writing at least part of each of the one or more activation vectors into a memory.

16. The apparatus of claim 15, wherein generating the one or more activation vectors comprises:
generating a global activation tensor by combining the collection vector with one or more additional collection vector, an additional collection vector generated in another PE group collection, the global activation tensor having at least two dimensions; and
rearranging elements of the global activation tensor to generate the one or more activation vectors.

17. The apparatus of claim 16, wherein the global activation tensor comprises rows, and a row comprises one or more activations from the collection vector followed by one or more activations from the additional collection vector.

18. The apparatus of claim 17, wherein the output tensor is generated in a PE array that includes the PE group collection and the another PE group collection, and the row of the global activation tensor comprises activations generated in PEs arranged in a same row of the PE array.

19. The apparatus of claim 15, wherein writing at least part of each of the one or more activation vectors into the memory comprises:
generating a compressed activation vector by removing one or more zero-valued elements from the activation vector;
generating a sparsity tensor comprising a plurality of sparsity elements, a sparsity element corresponding to an element of the activation vector and indicating whether the corresponding element is present in the compressed activation vector; and
writing the compressed activation vector and the sparsity tensor into the memory.

20. The apparatus of claim 15, wherein the operations further comprise:
determining a three-dimensional coordinate of an activation of the activation vector in the output tensor;
determining a memory address based on the three-dimensional coordinate; and
writing the activation into the memory at the memory address.
